(19) United States
(12) Patent Application Publication
(10) Pub. No.: US 2005/0033505 A1
(43) Pub. Date: Feb. 10, 2005

(54) Traffic surveillance and report system

(75) Inventor: Daniel Zatz, Homer, AK (US)

Correspondence Address: MCDERMOTT, WILL & EMERY, Suite 3400, 2049 Century Park East, Los Angeles, CA, 90067, US

(73) Assignee: Premier Wireless, Inc.

(21) Appl. No.: 10/726,249

(22) Filed: Dec. 2, 2003

Related U.S. Application Data
(60) Provisional application No. 60/431,117, filed on Dec. 5, 2002.

(51) Int. Cl. G08G 1/00; G06F 19/00

(52) U.S. Cl. 701/117; 340/905

(57) ABSTRACT

Traffic control systems, including an automated vehicle traffic assessment system. The system may measure and report on wait time and may include video cameras and image recognition software. The system may be used in connection with any flow-regulated area, including border crossings, toll roads and ports of entry.

### CROSS-REFERENCE TO RELATED APPLICATION

This application is based upon and claims priority to U.S. Provisional Application Ser. No. 60/431,117, filed Dec. 5, 2002, entitled TRAFFIC SURVEILLANCE & REPORT SYSTEM, the entire content of which is incorporated herein by reference.

### BACKGROUND OF THE INVENTION

The invention is directed generally to traffic control systems, and particularly to an automated vehicle traffic assessment system, and more particularly to wait-time measuring and data reporting system that includes video cameras and image recognition software used for monitoring roadways that are flow-regulated, for example, at a border crossing or port of entry. The system can also be used to monitor boat traffic in ports of entry or monitor toll-crossing road stops.

### BRIEF DESCRIPTION OF DRAWINGS

FIG. 1 is an elevated perspective view of a vehicle checkpoint.

FIG. 2 is an illustrative example of an on-screen display for a preferred embodiment of the present invention.

FIG. 3 is a block diagram of a portion of a preferred embodiment of the present invention.

FIG. 4 is a flow chart of the traffic flow component of a preferred embodiment of the present invention.

FIG. 5 is a flow chart of the traffic flow image component of a preferred embodiment of the present invention.

FIG. 6 is a flow chart of the end of line main component of a preferred embodiment of the present invention.

FIG. 7 is a flow chart of the end of line image processing component of a preferred embodiment of the present invention.

FIG. 8 is a flow chart of a preferred embodiment of the program overall operation.

FIG. 9 is an illustrative checkpoint image showing computer generated width line with the width measurement displayed.

FIG. 10 is an illustrative detail view checkpoint image showing the computer generated width line with the colored lane identifiers in place on the display screen.

### DETAILED DESCRIPTION OF THE INVENTION

The system comprises video cameras and image recognition software to monitor traffic at a predetermined location for the purpose of determining and reporting the wait-time for vehicles waiting in line at locations, such as a border crossing, port of entry, stop light or other locations where traffic may be stopped. In the preferred embodiment, the system also provides data about virtual conditions, including reporting data about the implications of opening or closing one or more lanes of traffic and the effects of a change in the rate of arrival of new vehicles into waiting traffic lines. For example, the system can predict how the total wait time would change if one lane of a border or toll crossing was closed or opened. In another example, the change in the total wait time could be estimated where the current arrival rate of vehicles increased—to simulate rush-hour traffic, for instance. Additionally, the system may provide data about the waiting vehicles including the color, make, and speed of each vehicle waiting in line. Further, the preferred system can provide data about the width, length, and height of each vehicle waiting in line, and this data may be used to identify specific vehicles types.

The system can be used by an administrator at border crossings or port of entry where the administrator may desire to know the length of time a vehicle will wait in line if it arrives under the current traffic conditions. This information can provide the administrator with data that is helpful in deciding whether to open or close additional lanes, or make other changes in the operation of the crossing or port. This can have significant impact on commercial and private traffic. In the preferred embodiment, the system may use a variety of commonly known data delivery techniques including instant phone messaging, e-mail, facsimile, etc., and data from the system may also be made available to drivers in vehicles enroute to the area, to allow drivers to find alternative routes during periods of long wait-times.

The system uses data provided by video cameras and processed by image recognition software to determine the flow rate of vehicles passing through gated areas or exit lanes. The system automatically detects the end of the line of vehicles and calculates the total number of waiting vehicles and the wait time for the vehicles. The system thus allows for the capture of live images of traffic conditions while image recognition and processing software analyzes the video to produce real-time or archived data about current traffic conditions. One of the unique aspects of the preferred embodiment of the system is its use of two primary components to determine the overall wait-time. These components include fixed or movable cameras that monitor the exit lanes to determine the vehicle flow rate of traffic through the border crossing, and these cameras work in combination with the second component which includes a combination of fixed and movable cameras to automatically search for and find the end of the current traffic line and determine the total number of waiting vehicles. The system may also use image recognition or other methods to deliver data about the total number of vehicles waiting in the targeted lanes.

In a preferred embodiment of the present invention, the system also uses two methods to reduce number of cameras needed to find the end of the line and count the number of vehicles waiting (and determine total wait time) along a roadway. These methods also improve the useful range-of-view of the cameras.

The first method is automatic image registration. This method allows the system to use movable cameras with high telephoto lenses that are focused on very distant objects. Because of errors in most common camera pan/tilt mechanisms, use of image subtraction techniques for finding new or moving targets is normally not practical at high telephoto (where mechanical errors by pan/tilt mechanisms are magnified). By using automatic image registration, the present invention can automatically correct for errors in the field of view. This allows for the use of image subtraction techniques because the computer can automatically make a pixel-to-pixel match between the current view and a previous view, even if the camera is not precisely aimed at the same location. This allows each camera to work in concert with image recognition software to provide coverage of a much broader area, thereby reducing the number of cameras needed and increasing the viewing range of the system.

A second method that allows the use of fewer cameras in this preferred embodiment is a method of counting vehicles using user input to supplement the system's vehicle count estimate generated by the image recognition software. Using this method, the user enters the total number of vehicles observed in each camera view during the system set-up phase. Once in operation, the system relies on this data during conditions when automatic counting techniques are unreliable. For example, during high-telephoto views vehicles become compressed, and image recognition software is normally incapable of separating the image into individual vehicles. This renders data from such views inaccurate. Without a method for automatically switching to manually counted data, operation of the system with high telephoto cameras would be impractical under most circumstances unless cameras were mounted on exceedingly tall structures.

Data from the system may provide users with information about rate of flow of traffic in each and all lanes, the total number of cars waiting, and the estimated wait time for vehicles in line or arriving at the end of the line. Other data may include information about the vehicles observed, including the color, length, width of each vehicle and averages of all vehicles.

One embodiment uses a third camera to gather data about vehicle profiles to allow for a vehicle identification system that employs both profile and overhead video cameras to provide width, length and height. Additionally, the data may include the direction of each vehicle, whether the vehicle was moving in the predicted direction, and the average velocity vector of vehicles. This information provides “Opposite Direction Of Travel” (ODOT) alerts, which are specifically used to alert border agents, port police, or other officials of vehicles attempting to enter a secure area via an outbound lane. All of this data may be used immediately or it may be archived. The data may be sent to servers in other locations, distributed to other interested users for display to email or cell phone messaging or to highway alert signs. The system may also capture still images and video clips of target events or objects, and this recorded data may be stored or sent to a user.

In a first preferred embodiment, the system is designed specifically to monitor traffic conditions at a border crossing or port of entry. In such a system, data is generated about traffic conditions including: rate of flow of traffic, number of vehicles waiting in line, and total wait time. Data is also generated that includes the number of vehicles arriving over time, ODOT alerts, speed, color, size, and type of vehicles waiting in line. This data is provided to users in the form of text and/or graphical information, including still images and video clips. Some data provides user alerts. For example, data about a vehicle traveling in the opposite direction of normal traffic flow will generate an ODOT alert. If one lane of traffic is flowing at an unusually high rate, another alert may be triggered to notify management of the condition, for example, if a border crossing agent is not thoroughly processing or inspecting vehicles. Based on the user's set-up values, alerts may be text, a still image capture, video clip of the event, email, or other messaging method. Data about a specific color or size of cars may fit a requested “search image” and may also trigger a user alert that will employ the sending of a text message, still image capture, video clip, or other messaging method.

Real time images may be delivered from video cameras to a computer via hardwire, fiber optic or wireless connection. The images may be from cameras that are positioned to determine the vehicle passage rate, or the images may be from cameras that are positioned to find the number of cars or end of the line. Images are in the form of analog or digital video and may be from visible light, infrared or thermal imaging cameras. The images are imported into a computer and are processed by image recognition software. This software may use several methods to determine whether cars are present in the field of view. The software may also use several methods to determine the direction/vector of travel of any moving vehicles. The methods used by the image processing software include, alone or in combination, texture, edges, image blurring, color, and target shapes/line segmentation. Other methods also may include image registration to assure accurate camera positioning, and image subtraction to find new and moving targets. In the preferred embodiment cameras used in the system are visible light, however infrared or thermal imaging cameras may also be used.

Besides monitoring border crossings, the system can be used to monitor traffic intersections to provide data about traffic wait times, number of vehicles waiting, flow rates, and other data about individual vehicles waiting in line. The system may also be used to monitor and provide data about boat traffic in harbors or at toll-crossing road stops.

In a preferred embodiment, the software also provides for a method to help the system's ability to focus on relevant image areas by the employing “target area painting” software tools that allow a user to define specific areas of each camera view that are target or non-target areas. The system may also use software that allows the computer to “learn” traffic conditions over time by storing and then comparing image recognition data including the following methods, alone or in combination: texture, edges, image blurring, color, target shapes and image subtraction. The process may be used to assist the image processing system in accurately identifying current traffic conditions.

In one embodiment, the software may display a user interface that includes the flow rate of traffic in each lane, the total flow rate for all lanes, the number of cars waiting in all lanes, and the total wait time. Other data displayed in the user interface may include ODOT alerts, color and sizes of vehicles, whether or not the vehicle fits a desired profile, charts that display a histogram of traffic flow/wait time/total number of cars, camera views, current camera, and current camera position. In another embodiment, the software may be used without a user interface to display real-time data. In this embodiment, the software delivers data to a separate program which makes use of the data, and this program may reside on the same or a different computer than the image processing system. In both embodiments, when a user interface is used and when one is not used, the software may include networking capabilities to provide for data export to other users or servers. Still images captured during alert conditions may also be displayed or sent to other users. Video clips of alert conditions may also be displayed or sent to other users.

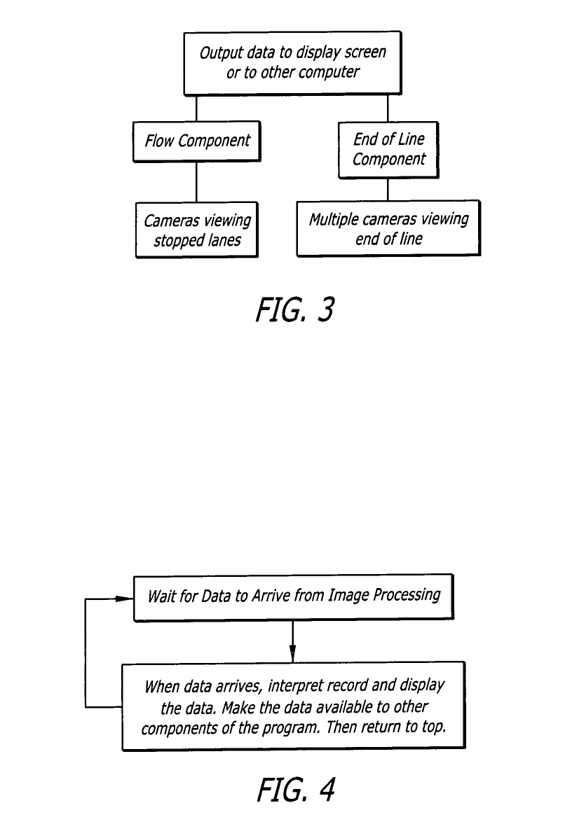

System Components. Referring to FIG. 3, a preferred embodiment of the present invention comprises a system composed of two image collection components. The first component monitors the number of cars passing through a border crossing (or any location at which vehicles must stop) hereafter referred to as the Traffic Flow Component, and the second component is the “End-of-Line Finding” component referred to as the End Of Line Component. Together, these provide a computer program with information about the total number of vehicles in the line and the rate of flow at the line's exit. This allows the computer program to calculate the total wait time at the location. The information also allows the computer program to determine the effects of adding more lanes (increasing traffic flow) or reducing traffic lanes (reducing flow) to establish virtual condition assessment. These flows are described in more detail below.

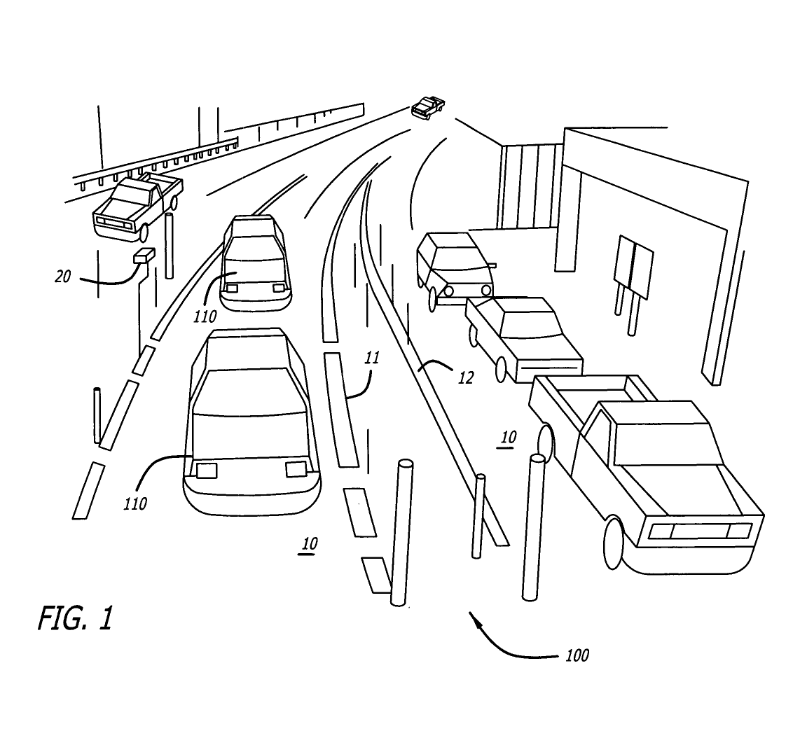

Traffic Flow Component. To determine the flow rate of traffic, a preferred embodiment of the system uses of one or more cameras (visible light, infrared or thermal imaging) aimed at the “gating” area—the area where vehicles either enter or exit the checkpoint. FIG. 1 shows details of a typical “gating” area 100. At this location, a number of lanes 10 are formed. The lanes are divided by lines 11 and/or barriers 12 as shown. In this way, lines of cars can be organized to help control traffic flow through the location. Cars 110 assemble into lines to pass through the station as shown. Cameras 20 are positioned as shown to monitor incoming cars. This is the area where cars are regulated so that a vehicle is stopped at a predictable location (within 10-20 feet), while the road area in front of the car is completely clear until this vehicle moves forward-either to arrive at a check point or exit it. The cameras 20 feed video into a computer 30 which uses one or a combination of several methods, discussed below, to determine when a vehicle is moving through a particular lane. This works in the following manner:

Set Up. In a preferred embodiment, a user sets up the area of the camera's view to be monitored by painting the area 25 of the lane with a marker color 26 to tell the computer program exactly which area is lane number 1, lane 2, lane 3, etc. Each painted area 25 can be labeled to identify the area. Similarly, the user can define each lane using a different color. Once this area is established, the user “clicks” on the colored area to bring up a text box in which the user can then enter a lane number. When a vehicle is detected moving across one of these painted areas 25, the program records activity in that lane. In another embodiment, lane markers 28 are defined by the computer as shown in FIG. 10. To do this, the computer is calibrated by monitoring a controlled video input for motion. Once calibrated, the computer automatically “paints” a pattern 29 based on the movement of vehicles during the initial calibration. This automatic set-up may then be modified by the user, as necessary.

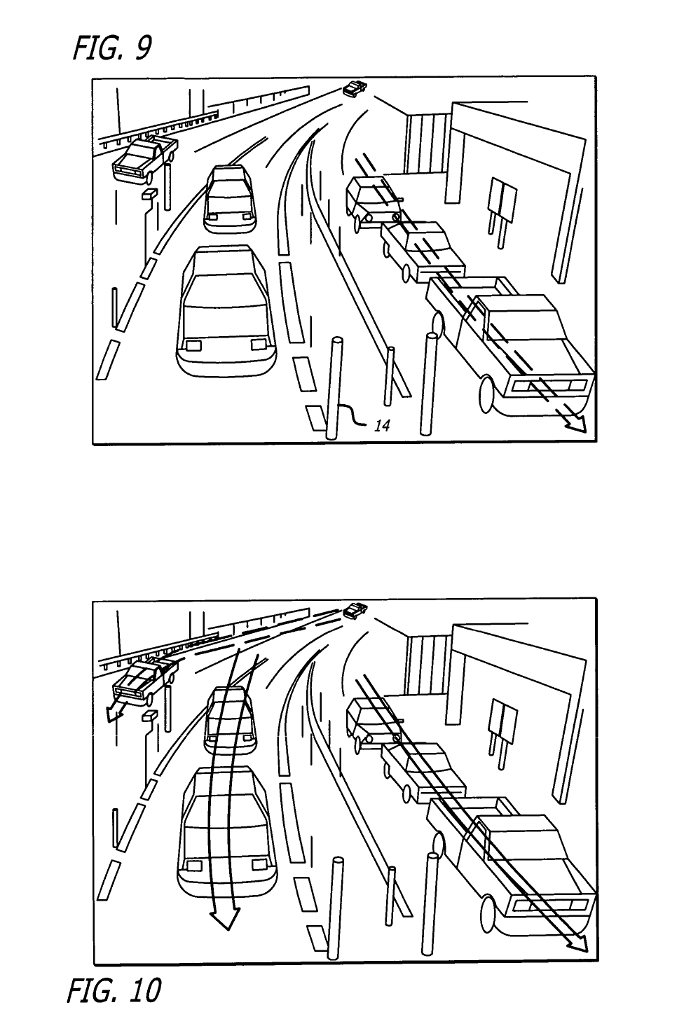

The user also may define “object length” information to the program. For example, the user clicks on the display screen of the computer and “pulls” a line across an object of any known length. The user then defines the length of the line by entering a line-length value into a text box, as shown in FIG. 9. Known as the “vehicle size” parameter, this provides the computer with a pixel/inch value that can be used to calibrate data delivered by the program to determine an object's length. This may be used to determine the width and length of vehicles, among other objects, and provide a basis for determining vehicle type.

In a preferred embodiment, the user may also define whether the computer should capture still images or video clips of target conditions including: Specific vehicles (based on vehicle color and/or size), vehicles that were stopped beyond or below user-set thresholds of time, and ODTO alerts.

Detection/image recognition-Image Processing. The invention will preferably use a computer with software to detect the presence or absence of vehicles. There are a plurality of methods for detecting images and the present invention may employ a variety of standard, commonly known techniques as described herein. In the preferred embodiment, the computer program employs one or a combination of the following image processing methods to determine the absence, presence, and relative location of vehicles in the field of view: texture, edges, line segments, shapes, and color (see description of these below). These may be combined with image subtraction techniques (motion) to determine whether vehicles are absent or present and, if present, their relative position in the field of view.

For example, the computer program determines when a vehicle is present in the target area by determining the contrast between an empty stretch of roadway and one with a vehicle one it. This method simply employs texture as defined below (see Texture Evaluation below). Because a roadway is relatively flat and has a generally low texture value, the change to a high textured area-as when a vehicle is present-can be used as a trigger event. The threshold for the trigger can be set manually, or by a combination of manual and automatic means. The automatic level can be based on an observed contrast, texture, or line segments over time. The automatic level may also consider these levels at the same time in previous days, to account for daily changes such as shadows. In addition to looking for shadows, the software may also look for edges, shapes, or colors. When using infrared or thermal imaging cameras, the system may also look for heat areas associated with each vehicle. Heat areas are treated in a manner similar to other image processing data where texture, edges and shapes assessments may be applied.

In another embodiment, the present invention detects motion by itself or in combination with other methods to determine when a vehicle is present (see Motion Tracking below). The system looks for significant change within a target area and correlates such a change with the presence of a vehicle.

In a third method, the software uses “image subtraction” (See Image Subtraction below) to determine whether vehicles are present. The program may also employ the use of texture, edge detection, color, line segment and motion path information (see description of these methods below) to determine the presence of and information about vehicles in the field of view.

The system may use a combination of one or more of the above listed methods to determine the absence or presence and location of vehicles. To anyone familiar with current image processing techniques it should be apparent that a variety of methods may be used to find vehicles.

To find the width and length of a vehicle, the system may use one or a combination of several of the above methods to “find” a vehicle and then calculate its width and length based on the calibration data provided by the user during program set up as described below.

Operation. In the preferred embodiment, operation of the traffic flow component is continuous while the program is active. All cars are monitored and data is made available to the program for displaying and storing flow rates for the lanes. The data is also made available to the system for calculating the total wait time (by using this data in conjunction with the total number of cars), and the data may be sent to a web page or other programs for use by other programs or display on the Internet.

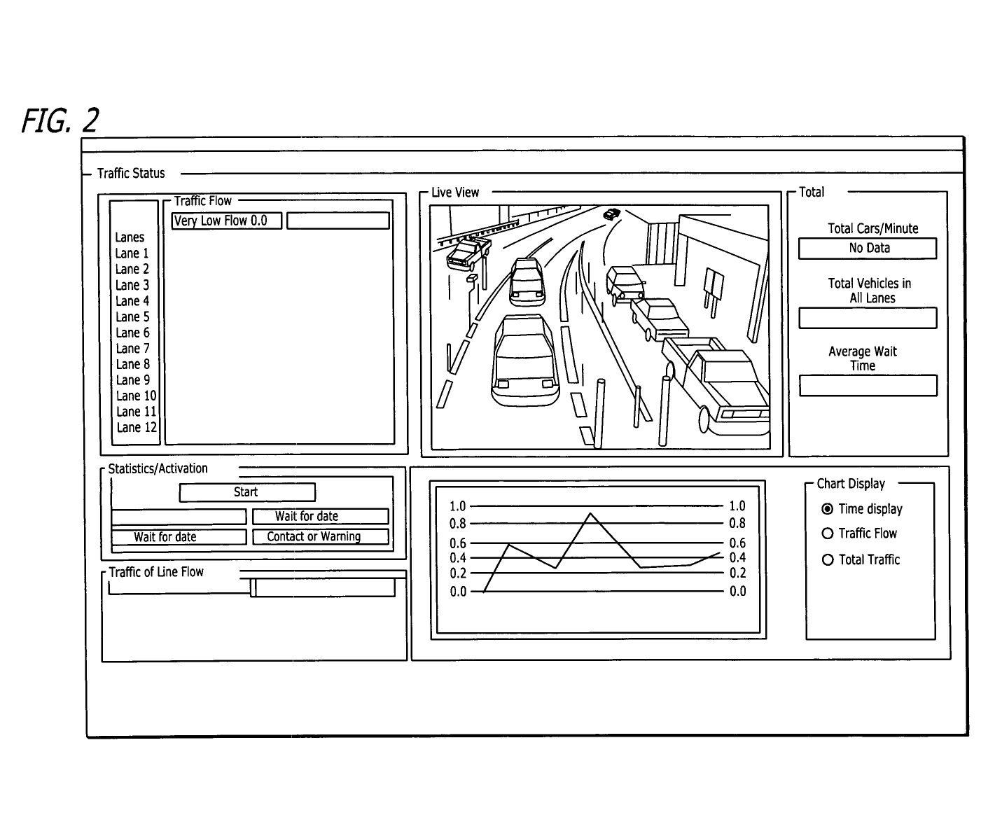

FIG. 2 is an example of a computer display of the present invention. It shows various data generated by the program, which is discussed in more detail below.

In a first preferred embodiment, the normal operational loop for this component (the traffic flow primary loop) is shown in FIG. 4:
1. Wait for data to arrive from the image processing component;
2. When data arrives, interpret record and display the data;
3. Make the data available to other components of the program; and
4. Return to number one.

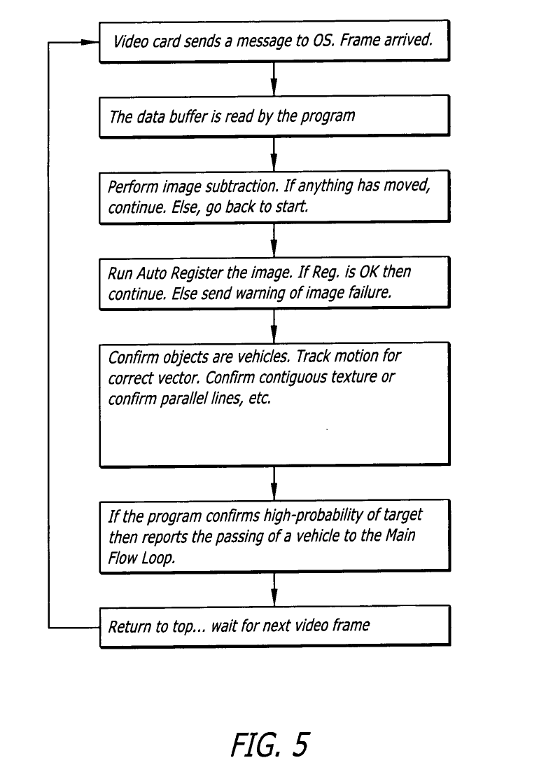

Referring now to FIG. 5, the image processing loop operates in this manner:
1. The video card sends a message to the operating system that a video frame has arrived; 2. The data buffer is read by the program;
3. The program Auto Registers the image (see Auto Image Registration below);
4. If the program detects that the camera position does not match the registration position, then a camera error has occurred and a warning is sent to user;
5. The program employs image subtraction (see Image Subtraction below) to determine if a vehicle is present;
6. If the image subtraction test suggest the presence of a target object, the data may be further evaluated to confirm that the objects are vehicles (not people, search dogs, etc.), including the use of motion tracking (see Motion Path Evaluation below), texture (see Texture Evaluation below), line segment (see Line Segment Evaluation below), and color (see Color Evaluation below);
7. If the program confirms the object is a vehicle, it reports the passing of a vehicle in the correct lane number (based on the position in the frame in which the motion occurred) to the Main Flow Loop; and
8. If no vehicles are detected, the image processing loop continues evaluating the video frame buffer data from the video card.

End of Line Component. The end-of-line component provides information on the number of vehicles that are waiting. The term “waiting” implies vehicles that are moving at a rate defined by the user at startup with a default of approximately 5 miles per hour. This component uses information gathered from one or more cameras, movable, fixed or a combination of both, that provide video data to a computer that processes the video. In a preferred embodiment as described below, this component uses a variety of image processing techniques to determine where vehicles are located, the vehicle's trajectory and speed. Once vehicles are identified, the computer calculates the total number of vehicles that are considered to be “waiting”. This number is divided by the flow rate to produce a “total wait time” value. Additionally, data gathered from moving vehicles is provided to the computer to generator “ODOT alerts” if vehicles are moving in a non-standard manner. ODOT alerts are triggered when a target object does not move in the direction previously defined by the user during the program set-up phase as described below. ODOT alerts can be calculated by monitoring each target object and determining whether it is moving across the screen in the predefined direction. For example, if the user defined “expected traffic flow” to be from the upper left of the screen to the lower right, then the computer would not trigger ODTO alters for any target object moving in this direction. However, if an object is moving across the screen in a direction significantly different from the predefined direction (the threshold for this is defined by the user on the preference page of the program prior to running the program), an ODOT alert will be generated.

Set UP. In a preferred embodiment, setting up the program requires a user to specify key information. The information needed by the computer to accurately provide traffic information includes instructions for where to position movable cameras, camera view order, defining traffic lanes for each camera view, defining the number of vehicles in each camera view (and in each lane within the camera view), and the camera view order, and defining the default “wait time” for each new camera position.

Defining Camera Positions. The user moves one or several cameras to desired positions and then stores these positions as presets. The object is to provide camera coverage of the entire area in which traffic monitoring is desired, from the “gating/border crossing area” to the furthest part of the roadway where traffic may be backed up to.

Defining Camera View Order. A user may also define the order in which the computer calls each camera position and each camera (if more than one camera is present). For example, the user may send a command to move the first camera to a view of the road nearest the “gated or border crossing” area. The user may then define this as camera position number one. The user may then command the camera to move to a position where the next section of roadway can be viewed, and the user may then assign this position and camera as position number two. If the user then desires to use a view from another camera to view the next section of roadway, the user would then send a command to switch to the new camera and the new camera position. The user would then define this camera and its current view as position number three, and so on.

For example, this can be achieved by using multiple movable cameras to monitor a length of road of several hundred yards to many thousands of yards long. The cameras may be moved by using a camera control page on the user interface, and specific position for the cameras are set and stored. The position includes pan, tilt and zoom. Also, fixed cameras may be positioned in a manner that allows multiple cameras to view a desired roadway. In either case, a user interface allows a user to select the “view order” which defines a camera order from nearest to farthest. This information is used by the computer to progressively scan a line of vehicles and to know which camera view is the next view for the computer to switch to as data is gathered about a long line of vehicles.

Defining Lanes. Once the camera views are set and ordered, the actual lane areas may be defined. The lane areas can be defined either by a user painting the image or by the computer automatically by entering set-up mode and allowing the computer to track motion to automatically define lane areas.

Within each camera view, the area of each frame that the system should search for vehicles can be defined. This is the “traffic area” and by defining this area, the user may reduce the total number of pixels the computer needs to review for each camera position. To define the traffic area, a user may use one of several methods. A user may obtain a still image of each camera view and then paint the area where traffic is expected. The user may paint the area with a bright, highly saturated color to identify a lane as a “target area” as shown in FIG. 10. The user may also define an area by painting on a “live” video screen, rather than a still image. The user may assign a different identifier to each lane by using different colors or by entering data in a text box. In either case, the user may also define the direction of traffic to provide a vector reference for ODOT alerts. To do this, the user may “click” on the image and drag an arrow in the direction of motion the user expects.

The “target area” may be defined automatically by the computer. In this method, a user instructs the computer to monitor motion within the camera view. The area in which motion occurs within the area during the set up time is automatically defined by the computer as “target areas.” While the computer gathers data on motion areas, it also gathers vector data-defining the direction that motion should be expected in each field of view.

Defining the number of vehicles. The user may also provide the computer with data about the total number of vehicles associated with each camera view. This may be accomplished by having the user assign a “vehicle waiting” value to any location within each field of view by entering a wait time data in a text box. For example, the first camera view (the one closest to the border crossing) might be labeled with a “0” near the crossing portion of the field of view and a “16 on the opposite site of the view area. This would mean that if vehicles are detected filling half of the field of view, that approximately 8 vehicles are waiting in line. If vehicles are found to fill none of the frame, then 0 vehicles will be reported. In this case the computer would automatically switch to the next previous of view (unless the current view is the first view) because this field of view shows that the end of line is somewhere before this camera view. The system may also determine the number of vehicles by “counting” the total number of vehicles it finds in each camera view. To automatically generate the total number of vehicles, the computer “counts” the vehicles present at the first camera view, and then it adds this number to the count at the second camera view, and so on. Once a camera view is reached in which the lane is not completely full of vehicles, the computer may end the addition process. The vehicles can be counted by the computer by a method described below.

Defining default “waits time.” In a preferred embodiment, the user may also define a default wait time for each new camera view. By defining this time, the user instructs the computer how long to “wait” at each new camera position while it collects image processing data. A typical time range is 20 to 40 seconds, and such time may be useful to help the computer confirm the presence or absence of vehicles. This is especially useful during times when the computer relies on motion information. If traffic is completely stopped, a longer “wait time” defined by the user will allow the computer more time to view motion in the frame and confirm presence of vehicles.

The user may also define the vector deviation tolerance. This value is entered on the set-up page and provides the system with the allowable degree of offset between the defined path of motion and the current path of motion before an alert is triggered. This feature allows users to adjust whether an alert is triggered for a vehicle that simply changes lanes or one that is driving the wrong way (180 degrees opposed to traffic) in a lane.

The user may also define the relative motion that a vehicle/target may move before it is considered to be “waiting”. In a preferred embodiment, this value provides the user with a method for adjusting the total wait time based, in part, on the speed of the waiting vehicles. This value may be used by the motion tracking method of the image processing function.

Image Processing. In a preferred embodiment of the present invention, a computer program employs one or more of the following image processing methods to determine the absence, presence, and relative location of vehicles in the field of view (from visible-light, infrared or thermal-imaging cameras): Texture, edges, line segments, shapes, color, and motion (see description of these below). These may or may not be combined with image subtraction techniques to determine whether vehicles are absent or present and if present, their relative position in the field of view.

Operation of End of Line Component. In a preferred embodiment, the end of line component of the system operates in two states: Startup and Normal operation mode.

Start Up Mode. During the startup mode, the computer program sends a command to selects the camera view of the roadway closest to the gated or border crossing area. The computer then processes the incoming video to determine if the current view if full of vehicles, partially full, or empty. The computer does this by “searching” for vehicles as described in “target finding”. Based on the determination, the computer may select the next camera view, a previous view, or it may keep the current image select. In the case of a partially filled lane, the camera may not be commanded to move to the next/previous position. If the view at the first position reveals an empty or partially filled lane, the camera will stay at the current position. While the computer is determining the lane's fullness, the computer may gather data on the motion of the vehicles, the number of vehicles, and other unique features of the vehicles (or other objects like humans, dogs, etc.) in the view. The computer stays in Set-Up mode until the computer detects that the current view is either empty or partially full of vehicles. Under these conditions, the end of the line has been reached, and data on the length of the line may be reported to the user or other peripheral devices. When the Set-Up mode is exited, the program enters the Normal Operation mode.

Normal Operation Mode. While in operation mode, the computer monitors the current view and moves the camera from one position to the next. The computer assesses the images from the current view and determines whether the current view is empty, partially full, or full of vehicles. For example, if the computer determines that the current lane view if full of vehicles, it may send a request to attached hardware (cameras and/or video switcher) to view the next section of roadway. This request can be either a request to move the current camera to its next position or to select a different camera. The computer will then evaluate the new camera position as outlined above and either move to the next position, stay at the current position or return to the previous position. If the computer recognizes that no vehicles are present in the new position, it will return to the previous view and it will extend the “wait time” at this position. By extending the wait time, the computer suppresses the possibility of an endless oscillation between two camera positions. The wait time may be returned to the default value when the computer detects a lane that is partially filled with vehicles.

There are two end-of-line loops running on separate threads of the program. These include the Main loop for camera control/data assessment and the image processing loop.

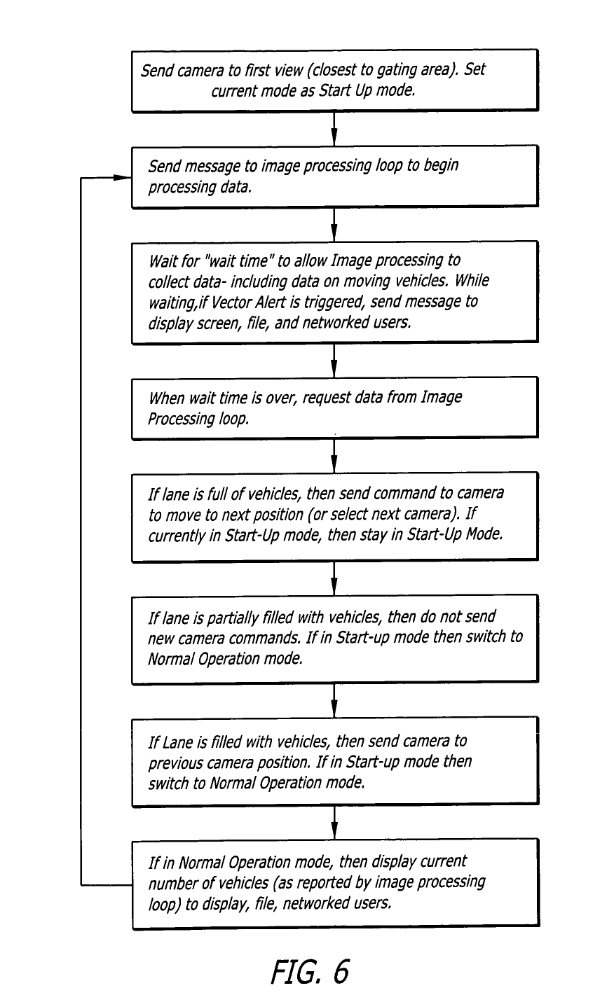

FIG. 6 shows the end of line main loop. In one embodiment, the program follows the following instructions. First, it clears all variables and calls the first camera view. Then it enters the main loop. In the main loop, the software instructs the image processing component to begin reviewing video data and passes the image processing component information on the current camera position including current zoom position. The system then waits for the current wait time (usually the default time) and allows the image processing component of the program to evaluate the current field of view to find what portion of the current view has vehicles. During the wait time, the image processing component monitors all vehicles and reports immediately if an ODOT alert occurs. All other data may be passed from the image processing component as it is collected or at the end of the wait time. Once the wait time is over, the program request data from the image processing component.

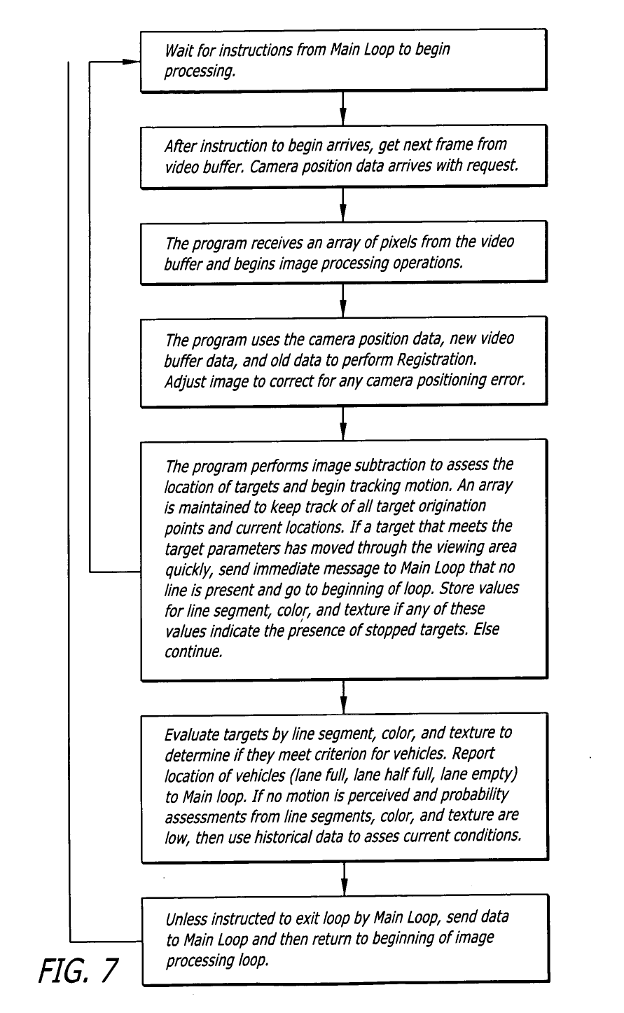

FIG. 7 shows the end of line image processing loop. Here, when data arrives from the image processing component, the system evaluates the image processing data (reported as Lane Status (LS)):
a) If the lane is full of vehicles, it calls the next camera view. Then it goes back to the start of the loop and reevaluates the scene;
b) If the lane is partially full of vehicles, then the program leaves the camera in its current position. Based on how much of the frame is full of vehicles, it generates a “total number of vehicles waiting” number by interpolating between the values provided by the user during set up or by the computer through vehicle counting. Then it goes back to the start of the loop and reevaluates the scene.

If the system perceives no vehicles in the lane, it then goes back to the previous camera position. If the current camera position is position number 1, it then reports that no vehicles are waiting and goes back to the beginning of the loop and starts again.

While this loop executes, data is continually collected by the traffic flow component. Also, the program will respond to any user requests while all of these loops are executing. These include requests for any information or any changes in operating parameters.

Image processing loop. Referring now to the flow chart of FIG. 7, the image processing loop follows the following instructions:
1. The program receives notification from the operating system that a frame of video is available. The image processing code requests data from the video card buffer once the program main loop instructs it to begin processing. Once processing begins, the program goes to item number two;
2. The program receives an array of pixel data from the video buffer; and
3. The program performs an “Auto Image Registration” (as described below) to confirm that the current image is valid the camera is working and pointed at relatively the correct position.

4. The program uses image subtraction (see Image Subtraction below) to compare the current image to the previous image as described above. If no new objects are found, the current “Lane State” (LS) is set to “Empty”. If objects are found to fill a portion of the frame then the LS is set to “Partial”, and if objects are found throughout the frame, the LS is set to “Full”. The LS is reported upon request from the Main Loop, which may request the data when the “wait time” has expired. To confirm results from image subtraction or during conditions in which image subtraction can not provide high confidence data, as determined by observing erratic variations in both traffic areas and non-traffic areas of the scene, the system may rely on one or more of the following methods to confirm the objects are vehicles. In all of the cases below, the program may use pixel values from areas in the frame defined during user set up as “target areas” or lanes of traffic:
a. Texture-look for contiguous smooth texture areas of specific sizes based on current zoom setting;
b. Line segments-look for line segments of defined lengths based on current zoom length. For example, the program will report finding parallel lines if they are within a distance of one-half the overall length of either line. Such lines suggest the presence of a car windshield, hood, window, etc.; and
d. Color-look for contiguous high saturation colors. While not all cars have such characteristics, the presence of some targets that fit this description provides valuable data. For example, the presence of multiple highly saturated objects in the traffic lanes can confirm that the LS should not be reported as “Empty”.

5. Track the motion of each object. Compare the motion path of the object over time with the expected trajectory path set up by the user. If the observed trajectory path is greater than the default amount, send a trajectory alert to the user. If an object is tracked moving through the entire frame within a default amount of time, the image processing component will send an immediate message to the Main Loop that the current LS is “EMPTY”. The current image subtraction, texture, color and motion data will also be stored as a body of data that signifies conditions where there is an empty lane. This becomes useful under conditions described below.

If the image processing component determines that no vehicles are present based on the above, the system may use other data collected to “learn”. For example, if image subtraction and texture assessments indicate that many vehicles are present but a target is tracked moving through the entire camera view, then the program may “learn” that current image subtraction and texture information provide unique conditions that should be assessed more carefully. Such assessment may include extending the “wait time” to allow more time to collect data under such conditions, and comparing current conditions to conditions during the same time on the previous day (in the case of shadows appearing or lights coming on/off). If, for example, a lane is empty but a flashing police light reflects off of roadway puddles, the computer may interpret this information as the presence of many “moving contiguous, high color saturation objects” which may suggest that the lane is full of vehicles. However, data provided by one vehicle moving quickly through the frame will confirm that no traffic is present since the car could not have driven through all of these vehicles. The system learns from these conflicting conditions and uses a history of previous conditions during its processing loop.

If the image recognition process determines that the lane is partially filled with vehicles, and the camera is not at a high telephoto lens condition, then the computer may report the number of vehicles in the current view (added to the total number from all previous camera positions). If the camera is at high telephoto, then the number that may be reported will be based on the number entered by the user during set up. In this case, the number of vehicles reported is proportional to the percentage of the screen currently full of vehicles. For example, if the user set up the current camera view as having 120 vehicles at a minimum and 160 at maximum (when all lanes in the current view are full), then the program will interpolate and report that 140 vehicles are present if the current camera view is half full.

Use of Data. In a preferred embodiment, the data collected from each of the camera views along with the data collected by the traffic flow portion of the system may be stored on the local computer or sent to anther computer. Data may include, among other things, the total number of vehicles, average speed, lanes most often full/empty, and the percentage of vehicles moving at each trajectory, the colors of vehicles, the average length of vehicles, the individual length of each vehicle, the average width of vehicles, and the width of each vehicle.

Auto Image Registration. In a preferred embodiment, the program compares pixel data currently received to the pixel data from the “set up” position or another previous position. The system finds the “registration error” created by slight or major inaccuracies in camera positioning due to mechanical error-especially in high telephoto conditions, and applies an error correction value to all subsequent processes. To find the correct registration, the system may compare the position of the pixels from each of the two images and “slide” one of the images to the left, right, up, down, up/left, up/right, down/left down/right, and find the position that best matches, or “registers”. The number of pixels and the direction of pixels that the registration is “off” is the correction data used throughout the image processing routines. If the registration error is beyond acceptable bounds, the program will report a “camera position error” to flag a request for user input. This system protection provides users with alerts of problems with camera mechanical devices, camera fogging, and other conditions that render the imaging system incapable of monitoring a predefined area. This is a useful component to assuring accurate data.

Image Subtraction. In a preferred embodiment, the system may use image subtraction to detect the presence of target objects such as vehicles. It does this by employing standard image subtraction techniques to determine when “new objects” are present. To do this, the computer looks at the pixel value of each or a select group of pixels in the video frame, where each of the pixels that represents an image of video has a pixel value characterizing the pixel intensity, and/or color. Data from initial frames are grabbed at times when no vehicles are present or when vehicles are present in the scene and then this data is compared with data collected throughout the operation of the program. At any given time, the program may compare the current video image to a previous image. By subtracting the current image from the initial image, an array of pixel value differences is derived. In the case where nothing has changed in a scene, the array/image resulting from subtraction of two sequential images is filled with zeros-a black image. If something has moved in the scene, subtraction produces a nonzero result at the location of the movement. The computer is then directed to begin working with the data of the nonzero pixel groups-which are considered to be candidates for being considered “target objects” or “vehicles”.

One key to this portion of the system may be to arrive at an array of pixel values that represent what the current scene would look like if no vehicles are present. To do this, the computer relies on a number of parameters to find a time when there is very high confidence that no cars are present and that the current image represents a “no vehicle” view. These can include one or more of the following methods: Waiting for conditions in which there is no movement for a predetermined amount of time, waiting for conditions in which the number of highly saturated pixels, i.e., pixels with high color value, are present, waiting for conditions in which edges and shapes that represent vehicles or vehicle shadows are not present, and waiting for conditions that closely relate to previously recorded scenes when the computer had a high confidence that no vehicles were present. In another embodiment, the program does not rely on waiting for an empty frame as the basis for image subtraction, but instead uses the difference, over time, to determine if motion is occurring. At the beginning of the wait time, the program may gather a series of images and then average these to get an “averaged view” of the lane. If vehicles are present and stopped, they will appear as solid or blurred objects. If vehicles are rushing through the lane, because there is no stopped cars, the rushing vehicles will be “averaged out” of the initial image and the remaining image will perceived as “road with no cars”. This image may be compared with a similar image created at the end of the wait time, and these two images may be compared against each other using image subtraction and other techniques to determine if vehicles are present or not. The system then finds a vehicle by evaluating whether the nonzero pixels are in contiguous groups large enough to be a vehicle. The threshold for such a determination may be made by defining vehicle size during set up for each camera position. Once a “target” is found, the computer may then monitor its movement. Here contrast, edges, or color may be used for evaluation of the scene. In either case, movement may also be tracked. Data from the movement can be used to alert users that a vehicle is moving in the correct/incorrect direction, and this may be used to alert users if a vehicle is attempting to enter a border crossing area on an outbound lane—thus triggering an ODOT alert to users.

Texture Evaluation. In a preferred embodiment, the pixels in the defined “target” areas are reviewed by the system and are searched for areas with strong intensity contrast. Since edges often occur at image locations representing object boundaries, this method may divide the image into areas corresponding to different objects. For example, this technique can provide data that the area under review is not an empty road, but a more complex, textured, object. This method allows the program to represent the target area of the image by its edges and therefore reduce the amount of data while retaining most of the image information-thus allowing other processing to be accomplished without hampering processor time. Since edges consist of mainly high frequencies, the program may also detect edges by applying a high pass frequency filter in the Fourier domain or by convolving the image with an appropriate kernel in the spatial domain.

Color Evaluation. The program may employ techniques of color evaluation to determine whether an object exists in an array of pixels and if that object may be a vehicle or other target object or not. The color evaluation process looks at each pixel's RGB, CMYK, or other color, hue or saturation value to determine, by processing, the values of the pixels' “color plane” values. The program then classifies, or aids in classifying fully or partially, the object as “target” or non-target. For example, the program may employ color evaluation by taking a video frame as input and then return as output how many objects are found, the coordinates of the center of each object, and the “color” of each object as classified into the classes “red”, “green”, “blue”, or ‘other’. The program may then use this information to conclude that a target with highly saturated red, for example, may only be a vehicle. This may be used to assist the program in finding and/or confirming previous data assessments. Practically, this is used to “confirm” the assessments of other functions in the program, and the program may not rely entirely on color data.

Line Segment Evaluation. The program may use line segments to determine or assist with finding the presence or absence of target objects. In this process, the system may use edge detection methods and evaluate the output of the edge detection process for attributes of length, direction, and (x,y) values for the center or for the endpoints of a found segment. Parallel lines found in defined target areas reflect with high confidence the presence of a vehicle. This data may be combined with motion path data to confirm the presence and movement of a target object. Because line segments are relatively invariant between consecutive frames and between ambient changes in lighting and color, this process can yield high-confidence data to the program.

Edge Detection and Evaluation. Conventional edge detection is used in the image processing component of the program to identify the boundaries of objects in a scene. The edge detection process used in the program takes one or more “pixels” in combination as input and by processing the values of the pixels' “color plane” values, classifies every pixel as part of an edge with a degree of certainty. The system may use edge detection to isolate a line in space by the grouping of contiguous edge pixels together as higher level objects, and using hysteresis to prevent streaking of the resulting line segments. These methods are standard image processing methods.

Motion Path Evaluation. In a preferred embodiment, the system's program may use data about the motion path of a group of pixels to determine if the group is an object, and to classify the object as a target or non-target object. To determine the motion path of a group of pixels or of a target or non-target, the program compares motion vectors as derived from the image subtraction process and calculated from one or more video features (using edge, color, segment data, etc.) to one or more previously specified path vectors to determine the motion of the video features. For example, this may be done by using the product derived between the two normalized vectors. If the product is 1 then the video feature is moving along the specified path. If the dot product is −1 then the video feature is moving against the specified path. If the product is zero then the video feature is moving perpendicular to the specified path. Under some conditions (as when a target is tracked through an entire frame along the predicted vector that a vehicle is expected to move) the motion path data provides high-confidence data of the state of traffic. This data may be used to trigger a learning event in the computer, and it may be used to confirm that the roadway is not full of stopped vehicles, among other things.

Vehicle Counting. In one embodiment, the program uses one or more of the following methods to find individual vehicles: contiguous areas of texture; line segments (for vehicles that are viewed from above or from near-top-down angle, two parallel horizontal lines filled in by a contiguous-color area may signify a single windshield—and this may be used for vehicles that are aimed straight at the camera, and tires may be viewed when the camera is placed at a near-perpendicular angle to the direction of moving vehicles; and continuous areas of color that are deemed by the computer to be large enough to be a vehicle or part of a vehicle such as a flat surface like hood, roof, etc. For texture, line segments and color, the determination of whether a target area is large enough is based on the vehicle size information provided in the camera set-up data. Because the size of a vehicle changes depending on the zoom value and distance between the vehicle and the camera, the user's initial set-up data can provide calibration data that the system can access whether line segments, texture or color areas are large enough to be considered targets. Once a target is considered to meet the criterion of texture, color, and/or line segment, the system may count the target as an additional vehicle and thus automatically add to the sum of all waiting vehicles.

Target Finding. Target finding includes the use of the above mentioned methods by themselves or in combination. These include: texture, line segments, color, and motion properties of the images. As discussed above, the program may use a variety of commonly known processing techniques to determine whether vehicles are present, where they are, and what their motion rates and vectors are. In one embodiment, the computer program is instructed to find areas of high texture within the targeting areas defined by the user. If a high texture area is found that matches the relative size of a vehicle (as defined by the user during set up), then the computer may apply a second test to the high texture area. This test may include looking for highly saturated colors which, if positive then the high texture area has very high probability of being a vehicle, or looking for line segments that match those of a vehicle. For example, if two parallel lines are found on a camera view that looks straight at an incoming vehicle, then the parallel lines will indicate high probability that the texture area is a vehicle. Next, the computer looks for motion. If the targeted objects are moving rapidly through the screen, then the computer can, with high probability of accuracy, asses the scene as containing no stopped traffic.

The End of Line Component may exist on the same computer as the Traffic Flow program or on anther computer. The programs may communicate with each other and other programs using a variety of communications protocols including Winsock ports. In a preferred embodiment, the program uses two computers, one for measuring traffic flow and another for the end of line component. Also, the Traffic Flow and End of Line components may each include at least one video card or other hardware method to allow video to be delivered to and processed by the computer.

User Interface. In a preferred embodiment, the user interface (see FIG. 2) provides real-time data and access to stored data for the following information which may be displayed as text, graphs or both:
1. Flow rate of vehicles per lane.
2. Total flow rate of all vehicles.
3. Number of vehicles waiting in traffic.
4. Total estimated wait time.
5. Rate of new cars arriving in line.
6. Adjusted estimated wait time (virtual wait time) if one or more lanes are opened or closed.
7. Adjusted estimated wait time if traffic arrival rates change.
8. The presence or absence of vehicles waiting in any single or group of lanes.
9. The presence or absence of a compact/medium, full-size vehicle waiting in line.
10. Number of compact, medium and full-size vehicles flowing through the line.
11. A history of any of the data collected from a previous time.
12. Camera position set up screen.
13. User specified data set up screen.
14. Image processing diagnostic screen showing target and non-target areas in real time.
15. Vector alert warning.

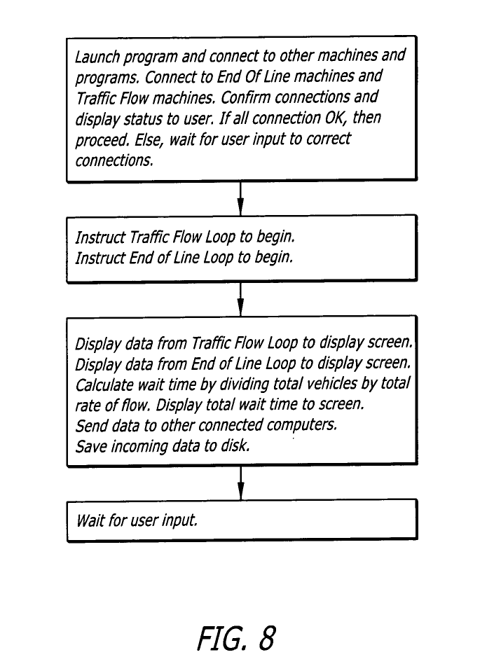

FIG. 8 is a flow chart of the overall system operation. It displays the overall steps of a preferred embodiment of the system's operation as follows:
1. Launch program and connect to other machines and programs. Connect to End of Line machines and Traffic Flow machines. Confirm connections and display status to user. If all connections OK then proceed. Else, wait for user input to correct connections.
2. Instruct Traffic Flow Loop to begin.
3. Instruct End of Line Loop to begin.
4. Display data from the Traffic Flow Loop to display screen. Display data from the End of Line loop to display screen. Calculate wait time by dividing total vehicles by total rate of flow. Display total wait time to screen. Send data to other connected computers. Save incoming data to disk.
5. Wait for user input.
   Process: How in the preferred embodiment of the system works:

The basic idea is to use multiple cameras and multiple preset positions for each camera, and user-specified settings such as where the road is on the screen and how far away various places are on the screen, to determine:
1) How many cars are waiting in the line?
2) What is the processing rate of the cars in each lane?
   The program will use these results to determine the current wait time.
   How many cars are waiting in the line?

In any given preset position, in order to tell how long the line is, the system relies on two pieces of information:
1) Where on the screen is the end of the line?
2) What distance (in number of cars) does that position represent?
Where on the screen is the end of the line?

For part 1 the program finds all pixels in the image that satisfy the following constraints:
1) The pixel is inside the selected road region.
2) The pixel is classified as ‘high motion’.
3) The pixel is classified as ‘high texture’.

Then the program finds all pixels that are within a given distance to these already chosen pixels. These pixels are then partitioned into groups of contiguous pixels such that there is a path from any pixel in a group to any other pixel in a group where every pixel on that path is selected. The program then attempts to match each pixel group to a previously existing pixel group. If no suitable match exists then if the group is sufficiently large it is categorized as a new car that has entered the scene. If it is not sufficiently large then it is ignored. Finally, the characteristics of each car is reported back to the program at the end of each frame. The attributes reported include the entrance distance of the car and the current distance of the car. The method of using this information to determine the length of the line is preferably in the program code. For example, a visual basic code could see that a car was picked up by the program when it was 100 car lengths away and that the car is now 25 car lengths away. From this information it could be assumed that the length of the line is at most 25 car lengths since there is a car that drove that up to that point without stopping. This is effective because if the car stops then the program may lose track of it since there is no motion.

The road region. The road region for each camera preset position is supplied by the user in the form of a bitmap file of the view of a given camera preset position the user has modified using an image processing application. The necessary modification is the selection of the region that could possibly contain cars (the road) by painting it a bright color. The program detects a large brightly colored area of the bitmap file and saves the position of these pixels for later use. The eventual use of these regions is to reduce the amount of processing needed per frame by ignoring regions where it is known that there aren't cars. An additional use is to reduce the number of false alarms that would occur when something that is not on the road exhibits characteristics that would be mistaken as car-like.

The pixel classifications. Every pixel on the screen at any moment in time is classified as having either high or low motion and as having either high or low texture. Each pixel has the opportunity to change state when each frame comes in. If the pixel is classified as high motion and is judged to have motion greater than the default minimum then the motion is reclassified as low motion. If the pixel is classified as low motion and is judged to have motion greater than the maximum then the motion is reclassified as high motion. The process is analogous with the texture state of each pixel. Notice since max>min that there is some hysteresis available so that the pixel states don't oscillate between low and high due to noise in the image.

The selection of neighboring pixels. If a pixel is next to an existing ‘car’ pixel then in the next iteration this pixel will be included as a ‘car’ pixel. This iteration is performed two or three times to expand the range of the ‘car’ pixels. The reason for this is that sometimes a car will be represented by several very close pixel groups that this operation combines into a single pixel group.

The division into contiguous pixel groups. A list of pixel groups is kept. Each pixel group is a list of pixels such that there is a path from any pixel in a group to any other pixel in a group such that every pixel on that path is also in the group. First the list of pixels groups is initialized to be empty and each pixel is marked as not being part of any group. Then iterate the following two steps until no suitable groups are found:
1) Find a pixel that selected as possibly being a car due to location in the mask and texture and motion and that is marked as not belonging to a group. If no such pixel exists then this part of the program is done.

2) If a pixel was found then use this pixel as a seed for a flood fill algorithm that adds all the filled pixels to the group list and also marks all the filled pixels as belonging to a group.

Finding a corresponding pixel group from a previous frame. An old list of pixel groups is maintained. The old group list keeps track of the x,y position of the center of each group. There is a need to determine how the new groups correspond to the old groups. So to do this where something looks like a car in an old frame and something looks like a car in the current frame and that if the centers of these objects are close enough then they probably represent the same car. The system matches the groups that are closest to each other first, up to a given distance apart. If a group from the current frame isn't matched to any group from the previous frame then if the group has enough pixels in it, it will be marked as a new group and its entrance position will be noted. If a group from the current frame is matched to a group from the previous frame then the most recent location of the old group will be updated to reflect the current position. The result is that cars can be followed from frame to frame and their position and entrance times and positions are known. These characteristics are useful for calculating line length as previously mentioned.

Now that the end of the line is on the screen, how many car lengths is the vehicle line?

Determining the distance of the group in car-lengths. As part of the setup of the program, the user must provide a way for the program to know how long the line is at various points on the road for each preset camera position. This is done by the user by adding ‘milestones’ to the picture (by clicking the mouse on it) and associating a distance (in cars) with each milestone. If the program wants to know the line length at a given point on the screen, it will find the point on the line between milestones closest to the given point and estimate the distance by interpolating between the values of the milestones on either side of it.

The processing rate of the cars in each lane. The program processes video from a fixed-view camera that can see all four of the lanes, for example. The job of the program is to notify a visual basic program when a car goes through a processing area. The visual basic program then effectively divides the number of cars seen by the time period giving the rate of car passage through each lane.

Implementation. A user provides location input to the program by painting red on a screenshot of the car passage area. The user paints one red spot for each lane. The red spot is painted to be smaller than half the width of a car and is at a place where motion represents a car passing through the area. At any given time the program is in the ‘car’ or ‘not car’ state for each of the four lanes. Each of the four lanes starts in a ‘not car’ state. For each frame, if the motion in a given lane spot is greater than a maximum amount then the state is set to ‘car’. If the motion in a given lane spot is less than a minimum amount then the state for that lane is set to ‘not car’. The motion is calculated as the sum of the absolute values of pixel differences between successive frames of video in each lane spot. When the state changes from the ‘not car’ to ‘car’ for a given lane, the program notifies the visual basic program that a car was found at that lane.

Appendix

Operation of the current embodiment uses two C++ programs to collect data. One C++ program processes image data from the traffic flow camera while the other processes end of line program. Data from both of these is sent to a single Visual Basic program which processes the data. Of course, as described above, there are a variety of embodiments which may be used to provide wait-time data at a boarder crossing. This particular embodiment, as reduced to function works like this:

C++ traffic Flow

1. Sends data to VB whenever a vehicle is detected moving over any defined lane
   C++ end of line
1. Sends data to VB at a rapid rate. The data includes information about targets which are found by looking for texture and movement.
2. Data sent to VB about each target includes:
   a. Time when tracking started
   b. Current time
   c. Position in frame where target was first detected relative to enter/exit of traffic
   d. Current position in frame relative to enter/exit of traffic
      Visual Basic

As detailed below, VB does the following.
1. Receive message from traffic flow when new car passes through any lane
2. Add data to array and calculate rate of flow per land and for all lanes
3. Receive messages at high rate from end of line C++ program
4. Ignore all data from end of line program until time is right.
5. Move camera to start position
6. Let camera settle (assure stopped)
7. Allow data from C++ to be processed. This includes data in C++ end of line item 2 above.
8. Wait for preset time (as set in default page)
9. Stop processing data from C++ and evaluate body of data received
10. Decide if current camera view is:
   (a) Full of cars
   (b) Partially full of cars
   (c) Empty.
11. This is based on:
(a) Did any car move from the entry point of the screen all the way through to a point near the exit portion in a short period of time. If so, then the lane does not have stopped traffic (lane is empty).
   (i) Report lane as empty
   (ii) Store the current overall texture of the camera view in the no_vehicles_textue_value_array.
   (iii) Move camera to previous position or select camera that views an area closer to crossing
(b) Were any cars found stopped or moving slowly near the entry point of the frame. This suggests the lane is full of stopped cars.
   (i) Report lane as full
   (ii) Store the current overall texture of the camera view in the Full_of_vehicles_textue_value_array.
   (iii) Move camera to next position or select camera that views an area further from crossing area.
(c) Were any cars found stopped or moving slowly near the middle of the frame. This suggests the lane is partially full.
   (i) Report lane as partially full
   (ii) Interpolate number of vehicles preset from percent of lane full.
   (iii) Don't move camera because it is looking at end of line.
(d) Was there no movement in the frame at all? If so, there may be no cars or traffic might be totally stopped and motion information is not useful. In this case, check texture values based on previous data. Compare the current overall texture values to those stored in Full_of_vehicles_textue_value_array and no_vehicles_textue_value_array. Determine where current texture falls.
   (i) If texture decides lane is full, move to next position
   (ii) If texture decides lane is empty, move to previous position
   (iii) If texture is inconclusive, the wait longer before making decision.
12. Combine total number of vehicles with data from total rate of flow to determine total wait time.
13. Report data to display or other users
14. Start collecting data from C++, and go through loop again.
   Visual Basic details:
1. Display connections page. Set variables. Open comm. Port
2. Clear all variables
3. Load settings
   (a) Remote connection settings (IP addresses)
   (b) Winsock port numbers
   (c) All wait time, sizes, camera positions . . .
   (d) Number of lanes to monitor
4. Load displays
   (a) Display lanes (text boxes, labels, graphs)
   (b) Position of forms
   (c) Position of text boxes, labels, etc.
5. Show connection page for startup
6. Connect to C++ Traffic flow program
7. Connect to C++ Flow rate program
8. Wait for ten seconds.
9. If connections are UP, continue. Else, send message to user that connections are down, need user input to correct connection problem.
10. Show Main Page if connect is UP and continue
11. Goto Start_Pressed sub routine
12. Start_Pressed

If Do_loop=true then ‘Do_loop is false first time through
Display status of loop as stopped
(i) Variable Release_wait=true (let all loops end . . . exit all wait times)
(ii) Make do_loop false

If Do_loop=false
(i) Display status of loop as running
(ii) Make do_loop true (loop will be active)
(iii) Last_Camera_Position=999′
(iv) Number_Of_Active_Seconds=0
(v) txtTotalVPL.Text=″″
(vi) START_MOTION_LOOP (this is a call to a sub routine).
   End start pressed
13. START_MOTION_LOOP
   Set the CURRENT_CAM_POSITION=0
   Set the “Last_File”=“XXX” ‘ something other than 1 to 100 Get_Final_Valid_Cam_Position ‘look at the stored data for all camera positions and figure out what is the Last_Enabled_Position
   Now, enter the main loop which will repeat as long as the program is collecting data:
   Main_Loop:
   If DO_LOOP Then ‘If the “Stop loop button has not been pressed
   ‘Move camera
   ‘ if in the last loop, the C++ code determined that the lane was either empty or full then goto the next camera position. Otherwise, don't tell the camera to move to the location it is currently at.

If Last_Camera_Position < >CURRENT_CAM_POSITION Then
Wait_Time=7000
   ‘goto here is a function that sends commands to the camera and switch to select the new camera position
   GotoHere (CURRENT_CAM_POSITION) ‘this sub routine sends the camera/switcher to the correct camera position.
      ‘clear all waiting loops
      RELEASE_WAIT=True
      ‘set variables for next loop
      Last_Camera_Position=CURRENT_CAM_POSITION
      ‘set variables for this loop
   ‘lowest blue is the lowest place on the screen (if cars are entering frame from the top, then the lowest blue is on the bottom. Blue signifies a color given by the program to a vehicle has entered the frame within 5% of the “entry line” for vehicles. We track a vehicle like this until it stops moving. Its value at entry is 100, but at half way down the screen its blue value is 50%. If it reaches 20%, then we have a vehicle that has move from the entry point to “very close to the exit point”. This will indicate that the program should consider the current view to be empty of waiting traffic. We start by setting the values of blue to 100.
   LOWEST_BLUE_PERCENT 100
   LOWEST_BLUE_DISTANCE=100
   ‘Green objects are objects that we started tracking in the middle of the screen. These may be vehicles that have been stopped, but are now moving. If there are no blue values that move very far through the frame, and there are moving objects (green objects) that start in the middle of the frame, then the program assigns the place where the line ends as the place where the highest value green targets are found. If there are no cars, then there would be no blue and no green targets. Set this to 0.
   HIGHEST_GREEN_PERCENT=0
      ‘how many targets are we tracking
   Max_Total_Tracked=0

‘when Goto_here is called, it set's waiting for move=true. This allows the goto_here to send the camera to a position and because it knows how long it should take for the camera to get there, it stays in this sub until the camera has theoretically reached its target. As we exit the goto here sub, Waiting_for_move is set to false. This releases the following while loop. This means that this routine holds up here until the camera move is complete.

Do While Waiting_For_Move

DoEvents

Loop

‘Data is arriving from the Find_End_Of_Line C++ program. While Allow_Data=false, this arriving data is ignored. This is due largely to the fact that the camera is probably moving or otherwise not ready to provide usable data. Here, we set Allow_Data=true so that we can start to build target data.

| | |
|---|---|
| ALLOW_DATA = True | ′let data arrive |

txtProcess_status.Text = “Waiting for data...”
RELEASE_WAIT = True

‘At this point the camera is no longer moving, and the C++ is reporting data that we are collecting in this program. Now we wait for the “waittime” to allow cars to move. Sleep2 (txtWaitTime.Text * 1000), True, Message ‘sleep for last 10 seconds
‘While data is arriving, Highest_Green_percent and lowest_blue_percent are being changed in other sub routines. See these to understand why they change. At the time when Allow_Data=false, we are ready to interpret the current values of the Green and blue variables.
ALLOW_DATA=False

‘if HGP is >70 then there were stopped cars moving in the furthest part of the lane. This indicates that the lanes in the current view are full. To help confirm this, we want to make sure that no car arrived from the furthest part of the frame (LBP) and drove lower that 80% of the frame. If these conditions have occurred, then the lane viewed by the current camera view is most likely full of cars. The likelihood is so high, that we should not only report that the lane is full, but also take a sampling of the current texture value at this time and store it for future reference.

If HIGHEST_GREEN_PERCENT > 70 And
LOWEST_BLUE_PERCENT
> 80 Then

′OK to set current condition as HIGH TETURE!. Do
this for
′Add one to the CONFIDENCE of the High Texture
assignment.
FDebug.Evaluate_High_Texture TEXTURE_VALUE,
HIGHEST_{—}
GREEN_PERCENT,

LOWEST_BLUE_PERCENT, CURRENT_CAM_POSITION

Save_Nural TEXTURE_VALUE, 0

End If

‘If it is ALMOST CERTAIN that the lane is empty then do the following.

‘This is a little confusing, but that makes sense because we will enter this condition if the data is not consistent with our expectations. In the following, we check to see if there is blue that is lower than green. If this is the case, then a car drove in from the top (meaning the lane is at least not completely full). Set the current lane fullness value based on this. But, if green is higher then blue, then a few possibilities exist. If green is really high, then the lane is probably full of cars. If green is higher than blue and Green is still NOT very high (below 70%), then the lane might be full (but no cars have moved), or it might be empty and no cars have driven in from the top. In either case, we should rely on the latest texture information (neural) to help decide the current condition.

If LOWEST_BLUE_PERCENT < HIGHEST_GREEN_PERCENT
Then

SET_LANE_FULLNESS_STATUS
(LOWEST_BLUE_PERCENT)
SET_TOTAL_TRAFFIC (LOWEST_BLUE_DISTANCE)

Else

‘if there was high green

If HIGHEST_GREEN_PERCENT > 70 Then

SET_LANE_FULLNESS_STATUS(HIGHEST_{—}
GREEN_PERCeT)
SET_TOTAL_TRAFFIC
HIGHEST_GREEN_DISTANCE(CURRENT_CAM_{—}
POSITION)

Else ‘maybe traffic is locked up and so we didn't get much good data and we should wait.

If GET_TEXTURE Then ′call function to decide if we should

consider
texture

SET_LANE_FULLNESS_STATUS (txtMax_Percent.Text +
1)

SET_TOTAL_TRAFFIC
HIGHEST_GREEN_DISTANCE(CURRENT_CAM_{—}
POSITION)
WAITED_FOR_ACTION = 0
GoTo TEXTURE_BYPASS

End If

‘The following is designed to allow for longer wait time to asses conditions if current data is inconclusive. Waited for action is modified within the following loops and checked here. If we have waited more than 3 times, then that's enough. Go forward and make the decision.

If WAITED_FOR_ACTION > 3 Then ′Max_Total_Tracked > 200

SET_LANE_FULLNESS_STATUS (HIGHEST_GREEN_PERCENT)
SET_TOTAL_TRAFFIC_HIGHEST_GREEN_DISTANCE(CURRENT_{—}
CAM_POSITION)
WAITED_FOR_ACTION = 0
List1.AddItem “Green is low, but waited long enough...”

Else ′there was not enough info to make a decision...

′wait for a while longer to decide...
WAITED_FOR_ACTION = WAITED_FOR_ACTION + 1
′don't change any data being displayed. Wait until the next time that
we enter the main loop.

SET_LANE_FULLNESS_STATUS (50)
SET_TOTAL_TRAFFIC (999) ′code to tell it to display “Collecting
Data”
List1.AddItem “Green is low, waiting is low. No updates...”

End If
List1.AddItem “WAITED_FOR_ACTION= ” & WAITED_FOR_{—}
ACTION

End If

End If
TEXTURE_BYPASS: ′come here and skip the above if we are using
texture only...
CAMERA_IN_MOTION = True
′Call Use lane status... which uses the data collected and decided upon
here.
USE_LANE_STATUS
End Sub
Sub USE_LANE_STATUS( )
Dim Message As String
On Error GoTo FINISH
′If Lane is HALF FULL

If LANE_STATUS = 1 Then ′report data to display

REPORT_DATA_TO_DISPLAY CURRENT_CAM_POSITION, LANE_STATUS

End If

′LANE IS EMPTY

If LANE_STATUS = 0 Then ′send the camera to the previous position unless it is

currently at 0.

′Go back 2 so that we can then go forward by one.
If CURRENT_CAM_POSITION < > 0 Then

RETURNING_FROM_RECONN = True

Else

RETURNING_FROM_RECONN = False

End If
If CURRENT_CAM_POSITION > 0 Then

If txtPositionLocation(CURRENT_CAM_POSITION).Text =

txtPositionLocation(CURRENT_CAM_POSITION − 1).Text Then

Send_Cam_To_Start (CURRENT_CAM_POSITION − 2)
Message = “Sending Camera to Start”
Sleep2 1500, True, Message

Else

Message = “Switch no cam. No move.)”
Sleep2 200, True, Message

End If

End If
If CURRENT_CAM_POSITION < > 0 Then

CURRENT_CAM_POSITION = CURRENT_CAM_POSITION − 1

End If
REPORT_DATA_TO_DISPLAY CURRENT_CAM_POSITION, LANE_STATUS

End If

′If Lane IS FULL

If LANE_STATUS = 2 Then ′go to next camera position.

CURRENT_CAM_POSITION = CURRENT_CAM_POSITION + 1
REPORT_DATA_TO_DISPLAY CURRENT_CAM_POSITION, LANE_STATUS

End If
If CURRENT_CAM_POSITION < 0 Then CURRENT_CAM_POSITION = 0
If CURRENT_CAM_POSITION > Last_Enabled_Position Then

CURRENT_CAM_POSITION = Last_Enabled_Position

End If

FINISH:
CAMERA_IN_MOTION = False
End Sub
′XXXXXXXXXXXXXXXXXXXXXXXXXXXXXXXXXXXXXXXXXXXXXXXXXXXXXXX
Function GET_TEXTURE( )

| | | |
|---|---|---|
| GET_TEXTURE | = | FDebug.GET_TEXTURE_DECISION(TEXTURE_VALUE, |

CURRENT_CAM_POSITION) ′Fdbug gets decision.
End Function
′XXXXXXXXXXXXXXXXXXXXXXXXXXXXXXXXXXXXXXXXXXXXXXXXXXXXXXX
Public Function GET_TEXTURE_DECISION(Current_HT As Long, Current_Cam_Posi
As Long)
Traffic.List1.AddItem “Using Texture:”
If High(Current_Cam_Posi) < 2000 Then

Traffic.List1.AddItem “Data too low:” & High(Current_Cam_Posi)
GET_TEXTURE_DECISION = False
Exit Function

End If
If High(Current_Cam_Posi) < Current_HT + 2000 Then

GET_TEXTURE_DECISION = True
Traffic.List1.AddItem “Texture OK: ” & High(Current_Cam_Posi) − Current_HT +

2000
Else

GET_TEXTURE_DECISION = False
Traffic.List1.AddItem “Texture Low: ” & High(Current_Cam_Posi) − Current_HT +

2000
End If
End Function
′XXXXXXXXXXXXXXXXXXXXXXXXXXXXXXXXXXXXXXXXXXXXXXXXXXXXXXX

‘This is the function that is called each time the C++ program sends data to the VB about end of lane conditions. This is called every 100 ms. Data is only used if Allow_Data is true. This is set in the main loop.

Private Sub Winsock_Line_Legnth_DataArrival(ByVal bytesTotal As Long)
On error resume next

Dim sdata As String
Dim CurrentUserIP

Call Winsock_Line_Legnth.GetData(sdata, vbString)′ sdata is the string that arrives.

We will parse this later.

LengthDataArrived = True
If ALLOW_DATA Then

′here is the call to do something with the data.

ProcessLLData sdata, bytesTotal

End If

End Sub
′XXXXXXXXXXXXXXXXXXXXXXXXXXXXXXXXXXXXXXXXXXXXXXXXXXXXXXX

‘This sub gets data from the C++ program, parses it, and assigns data to variables.

Public Sub ProcessLLData(D1 As String, bytesTotal As Long)
′Process the lane length data from C++
On Error Resume Next
Dim Temp As Long
Dim dat As String
NUMBER_OF_GREEN = 0
TRACKING_BLUE = False
TTC = 0
′parse the data
CS2( ) = Split(D1, “:”)
SITE_NAME = CS2(0)
CS2( ) = Split(D1, “:”)
′if we are building a data file for debugging...
If Build_Data_File Then Save_Test_File (D1)
Total_Tracked_Cars = 0
′Parse the data
For Temp2 = 3 To bytesTotal
On Error Resume Next
If CS2(Temp2) < > “ENTER_PERCENT” Then
′nada
Else

TTC = TTC + 1
ENTER_PERCENT(TTC) = CS2(Temp2 + 1) * 100
′ENTER_DISTANCE
ENTER_DISTANCE(TTC) = CS2(Temp2 + 3)
′ENTER_TIME
Enter_Time(TTC) = CS2(Temp2 + 5)
′CURRENT_PERCENT
CURRENT_PERCENT(TTC) = CS2(Temp2 + 7) * 100
′CURRENT_DISTANCE
CURRENT_DISTANCE(TTC) = CS2(Temp2 + 9)
CURRENT_TIME(TTC) = CS2(Temp2 + 11)
Temp2 = Temp2 + 11
Total_Tracked_Cars = Total_Tracked_Cars + 1

′Get the highest number of cars tracked. The more data the more confidence in the
decision.

If Max_Total_Tracked < Total_Tracked_Cars Then

Max_Total_Tracked = Total_Tracked_Cars

End If
On Error Resume Next

′Call this sub and do something with this data...
Process_Raw_END_Of_Line_Data (TTC)
txtLL(5).TabIndex = “Time_Tracked: ” & CURRENT_TIME(TTC) −
Enter_Time(TTC)
End If
If CS2(Temp2) = “MOTION” Then

MOTION_VALUE = CS2(Temp2 + 1)

End If′ < >“”
If CS2(Temp2) = “TEXTURE” Then

TEXTURE_VALUE = CS2(Temp2 + 1)

End If
SUBS:
Next
End Sub
′XXXXXXXXXXXXXXXXXXXXXXXXXXXXXXXXXXXXXXXXXXXXXXXXXXXXXXXX

‘this sub uses the data from the parsed C++ data to decide on blue and green percents. All subs are important, but this one is really important. Here, green and blue values are set following each delivery of data from the C++.

Private Sub Process_Raw_END_OF_LINE_Data(Temp As Long)
Dim TOP_VALUE As Long
Dim BOTTOM_VALUE As Long
Dim Move_Amount As Long
Dim TIME_IN_MOTION As Long
Dim Message As String
TOP_VALUE = 90
BOTTOM_VALUE = 15
If CURRENT_PERCENT(Temp) < Percent_Limit_Low Then

Move_Amount = 9 / (Zm + 1) ′Zm is the current
zoom level for the camera

End If
If CURRENT_PERCENT(Temp) >= Percent_Limit_Low And
CURRENT_PERCENT(Temp) <= Percent_Limit_High Then

Move_Amount = 6 / (Zm + 1)

End If
If CURRENT_PERCENT(Temp) > Percent_Limit_High Then

Move_Amount = 3 / (Zm + 1)

End If
CURRENT_PERCENT(Temp) & “ Move Amount:” & ENTER_PERCENT(Temp) −
CURRENT_PERCENT(Temp) & “ Move Amount Needed” & Move_Amount

‘if the tracked object has moved an amount great enough (based on current zoom level) and it has done this moving in the allotted time, then we will consider it valid data. Movement that occurs over a long period of time can be “ripple texture” which occurs from transference from one vehicle to the next even if the vehicles are not really moving.

TIME_IN_MOTION = CURRENT_TIME(Temp) − Enter_Time(Temp)
TIME_IN_MOTION = TIME_IN_MOTION / 10
′If it has moved enough
If ENTER_PERCENT(Temp) − CURRENT_PERCENT(Temp) > Move_Amount Then

′If it is not too old-if the data is not too old-compare when we started tracking this

to current time....

If TIME_IN_MOTION > 15 Or TIME_IN_MOTION < 0 Then

List1.AddItem “OUT OF TIME RANGE: ” & TIME_IN_MOTION & “ : Target

Location is: ” & CURRENT_PERCENT(Temp)

Else ′time is ok

′IF It entered at the top then we want to call this BLUE
If ENTER_PERCENT(Temp) > TOP_VALUE Then

TRACKING_BLUE = True

If ENTER_PERCENT(TTC) > 90 And CURRENT_PERCENT(TTC) = 0 Then

X = X

End If

′If this should be the new “LOWEST Blue value” . Otherwise don't use it...
If LOWEST_BLUE_PERCENT >= CURRENT_PERCENT(Temp) Then

′If it's high and long time then get out of here

If CURRENT_PERCENT(Temp) > Percent_Limit_High And

TIME_IN_MOTION > 8 Then

List1.AddItem “Timed Out Blue...1: ” & TIME_IN_MOTION: Exit Sub

End If

′If it's lower and very long time then gets out of here.

If CURRENT_PERCENT(Temp) <= Percent_Limit_High And

CURRENT_PERCENT(Temp) > Percent_Limit_Low And TIME_IN_MOTION > 12
Then

List1.AddItem “Timed Out Blue...2: ” & TIME_IN_MOTION: Exit Sub

End If
′if it hasn't timed out then proceed...
LOWEST_BLUE_PERCENT = CURRENT_PERCENT(Temp)
LOWEST_BLUE_DISTANCE = CURRENT_DISTANCE(Temp)

′If a car went all the way through

If LOWEST_BLUE_PERCENT < Percent_Limit_Low Then

RELEASE_WAIT = True ′let the sleep end because a car went all the

way through

′ALLOW_DATA = False
List1.AddItem “RELEASING WAIT!” ′ this could cause trouble because

of other sleeps while data is still being processed...?

Message = “Release Wait!”
End_Sleep = True
′Sleep 3000, True

′Store lowest texture

If HIGHEST_GREEN_PERCENT < 20 And

LOWEST_BLUE_PERCENT < 20 Then

′OK to set current condition as HIGH TETURE!. Do this for
′Add one to the CONFIDENCE of the High Texture assignment.
FDebug.Evaluate_Low_Texture TEXTURE_VALUE,

HIGHEST_GREEN_PERCENT, LOWEST_BLUE_PERCENT,
CURRENT_CAM_POSITION

Save_Nural 0, TEXTURE_VALUE

End If

End If

End If

Else ′Its green

NUMBER_OF_GREEN = NUMBER_OF_GREEN + 1
If HIGHEST_GREEN_PERCENT < CURRENT_PERCENT(Temp) Then

′STORE HIGHEST VALUES IN ARRAY
HIGHEST_GREEN_PERCENT = CURRENT_PERCENT(Temp)
HIGHEST_GREEN_DISTANCE(CURRENT_CAM_POSITION)

CURRENT_DISTANCE(Temp)

End If

End If ′Enter Percent is VERY HIGH

′Reverse Trajectory. To use the data, it can not have timed out...

If CURRENT_PERCENT(Temp) > ENTER_PERCENT(Temp) + 30 Then

If ENTER_PERCENT(Temp) < 15 Then ′only alert for things low in the frame...
′ start a timer. See how many VA you get in 2 seconds. If there are more
′than 5/10/20??? then trigger alert
List2.AddItem “Vector Alert ” & CURRENT_PERCENT(Temp) & “ ” &

ENTER_PERCENT(Temp)

btnVA2.Visible = True

End If

End If

End If ′Time in motion

End If ′Move amount
′Reverse Trajectory ODOT alert
If CURRENT_PERCENT(Temp) > ENTER_PERCENT(Temp) + 30 Then

If ENTER PERCENT(Temp) < 15 Then ′only alert for things low in the frame...

′start a timer. See how many VA you get in 2 seconds
List2.AddItem “Vector Alert ” & CURRENT_PERCENT(Temp) & “ ” &

ENTER_PERCENT(Temp)

btnVA2.Visible = True

End If

End If
′display data
Show_Results_From_Each_String
End Sub
′XXXXXXXXXXXXXXXXXXXXXXXXXXXXXXXXXXXXXXXXXXXXXXXXX

‘display data to txt boxes. Also store texture values. Also display data to progress bars.

‘this is the final step for data after it arrives from the C++—except that it will be used after ALLOW Data=false. Then this all stops and the main loop uses this data.

Sub Show_Results_From_Each_String( )
Dim Temp As Long
Dim Current_Tex As Long

txtLL(0).Text = “Current Blue : ” & LOWEST_BLUE_PERCENT
txtLL(1).Text = “Current Green: ” & HIGHEST_GREEN_PERCENT

′CURRENT_PERCENT(Temp)

txtLL(2).Text = “Current Texture : ” & TEXTURE_VALUE

For Temp = 0 To 10

If CURRENT_CAM_POSITION = Temp Then

′show the value for this one
Current_Tex = FDebug.GetTextureValue(Temp)

End If

Next

txtLL(3).Text = “Expected Texture:” & Current_Tex
FDebug.TXT_TOTAL_TRACKED.Text = “Max Tracked: ” & Max_Total_Tracked

′ txtLL( ).Text = “Total Tracked:” & Highest_green_target

PB_Percent(2).Max = 30000
PB_Percent(3).Max = 30000
PB_Percent(0).Value = LOWEST_BLUE_PERCENT
PB_Percent(1).Value = HIGHEST_GREEN_PERCENT
PB_Percent(2).Value = TEXTURE_VALUE
PB_Percent(3).Value = Current_Tex

End Sub
′XXXXXXXXXXXXXXXXXXXXXXXXXXXXXXXXXXXXXXXXXXXXXXXXXXXXX

‘While all of the above is happening, the other C++ program is collecting data on the flow rate of cars through the crossing. This sub is called each time the C++ gets data about flow.

Private Sub WINSOCK_FLOW_DataArrival(ByVal bytesTotal As Long)
FlowDataArrived = True
btnVA2.Visible = False

Dim sdata As String
Dim CurrentUserIP

Call WINSOCK_FLOW.GetData(sdata, vbString)

CurrentUserIP = WINSOCK_FLOW.RemoteHostIP

′process data with a call to the following...

ProcessFlowData sdata, bytesTotal
SM.txt_Data_arrives.Text = sdata

End Sub
′XXXXXXXXXXXXXXXXXXXXXXXXXXXXXXXXXXXXXXXXXXXXXXXXXXXXXXXX

Public Sub ProcessFlowData(D1 As String, bytesTotal As Long)
‘After data arrives on Winsock 1, we build the rate/minutes. This
‘data is looked at when tmrCarsPer_Timer fires.

‘if you click NO to virtually, then DO NOT DISPLAY. Data arrives here, but displays are not calculated here. Calculations and updates occur by calls from the timer . . . see below

Dim Temp As Long
Dim LaneNum As Long
Dim TheTime As Timer
Temp = 0
CS( ) = Split(D1, “:”)
SITE_NAME = CS(0)
SM.txt_City = SITE_NAME
On Error Resume Next
′parse the data string
For Temp2 = 2 To bytesTotal
If CS(Temp2) < > “TRAFFIC_FLOW” Then

GoTo Pass

Else

‘flip data to account for lanes . . . this can be done in a set up box by assigning each lane a specific number. Here is hard coded, but in another embodiment it might not be. This would allow the program to output the same “lane numbers” as the boarder agents know the lanes as.

If CS(Temp2 + 1) = 0 Then LaneNum = 3
If CS(Temp2 + 1) = 1 Then LaneNum = 13
If CS(Temp2 + 1) = 3 Then LaneNum = 12
If CS(Temp2 + 1) = 2 Then LaneNum = 2
If CS(Temp2 + 1) = 4 Then LaneNum = 11
If CS(Temp2 + 1) = 5 Then LaneNum = 1
If CS(Temp2 + 1) = 6 Then LaneNum = 10
If CS(Temp2 + 1) = 7 Then LaneNum = 0
End If
If LaneNum = 10 Then Lane_Good_to_go(0) = Timer: Exit Sub
If LaneNum = 11 Then Lane_Good_to_go(1) = Timer: Exit Sub
If LaneNum = 12 Then Lane_Good_to_go(2) = Timer: Exit Sub
If LaneNum = 13 Then Lane_Good_to_go(3) = Timer: Exit Sub

‘If the lane was not tripped in one second, then don't use the data. This protects from one car triggering multiple hits. We assume that if the C++ reads several cars in one second, then the threshold is off, and we assume that only one car went by. Since cars usually take 30 seconds or more, we can afford this buffer to protect from bad data.

′Check the time diff between the current time an the last time the lane was triggered
Dim TimeDiff As Variant
TimeDiff = (Timer − Lane_Good_to_go(LaneNum))
If TimeDiff > 2 Then

mnuCPM.Caption = “False Trigger ” & LaneNum
Exit Sub

End If
TimeDiff = Timer − Last_Trigger(LaneNum)
If TimeDiff < 20 Then

mnuCPM.Caption = “Rapid Trigger Lane #” & LaneNum & “ Not using data.”
Send_To_Error_File (LaneNum)
Exit Sub

End If
Do While CPS(LaneNum, Temp) < > 0

Temp = Temp + 1

Loop
′set when the lane will be ready for data again.
Lane_Good_to_go(LaneNum) = Timer − 2
CPS(LaneNum, Temp) = Timer
′SM.txt_Array_Timer
Last_Trigger(LaneNum) = Timer
Pass:
Next
txtDisp.Text = “Lane: ” & LaneNum & “ ” & CPS(LaneNum, Temp)
End Sub
′xxxxxxxxxxxxxxxxxxxxxxxxxxxxxxxxxxxxxxxxxxxxxxxxxxxxxxxxxxxxxxxxxxxxxxxxxxxx
xxx
Private Sub tmrCarsPer_Timer( )
′CPM= cars per minute

‘Here we look at data that was collected. The data arrived at winsock1 Dim Loop3 As Long
mnuLL.Caption=″″
UpDateArray ‘This is for traffic flow. Clear old times from Array so that in next function, ‘collectdata, we can count how many are left . . . which is the number of cars . . .
Collectdata ‘This goes through the array
‘and counts how many time-hits are in each array. Each hit is equal to one car.
‘This is where Rate_Of_Flow is set. Rate of flow is used in the next procedure
‘This is where flow data is displayed too.
TotalTrafficFlow’ collect all traffic flow data and display
‘This is where CPM is set . . . using Rate_Of_flow data.

‘Also display happens here for Total CPM . . .

′Send to remote clients all info from text boxes.
Send_To_Client
′For Loop3 = 0 To btnCam_Pos.UBound
′ btnCam_Pos(Loop3).BackColor = vbRed
′Next
On Error Resume Next
′btnCam_Pos(CURRENT_CAM_POSITION).BackColor = vbGreen
End Sub
′XXXXXXXXXXXXXXXXXXXXXXXXXXXXXXXXXXXXXXXXXXXXXXXXXXXXX

‘This sub builds an array for the cars per second per lane. The program is set for up to 19 lanes

‘but can be expanded here. We are building the CPS array here.

Sub UpDateArray( )
Dim TheTime As Timer
Dim Temp As Long
Dim Temp2 As Long
Dim TimeDiff As Variant
Dim RealTime As Single

‘set Cars Per Second array to 0 for events that are more than 60 seconds old ‘this will make the array ready for providing information on the amount of cars ‘in the last minute.

For Temp = 0 To 19
For Temp2 = 0 To 999

If CPS(Temp, Temp2) < > 0 Then

RealTime = Int(txtTime.Text)
TimeDiff = (Timer − CPS(Temp, Temp2))
If TimeDiff > RealTime Then

CPS(Temp, Temp2) = 0

′SM.txt_Clearing

End If

End If

Next
Next
End Sub
′XXXXXXXXXXXXXXXXXXXXXXXXXXXXXXXXXXXXXXXXXXXXXXXXX
Sub Collectdata( )

‘Here we add up the number of non-zeros in the CPS array. This is the final step in calculating the rate of flow per lane. Now the data can be used, in combination with the total flow and number of waiting cars to calculate the total wait time.

‘we also call to display the data in both the lane text boxes and the totals.

Dim Temp As Long
Dim Temp2 As Variant
On Error Resume Next
For Temp = 0 To 19

Cars_Moving_Per_Lane(Temp) = 0

Next
For Temp = 0 To 19
For Temp2 = 0 To 999

If CPS(Temp, Temp2) < > 0 Then ′If CPS has data for Temp, then that is one more

car that has passed in that lane. So now add one.

Cars_Moving_Per_Lane(Temp) = Cars_Moving_Per_Lane(Temp) + 1

| | |
|---|---|
| ′ | SM.t |

End If

Next
Next
On Error Resume Next
For Temp = 0 To txtNumOfLanes.Text

If LblLane(Temp).ForeColor = vbGreen Then

′If more than 60 seconds then take a fraction. Else, just take all cars that have passed.

If Number_Of_Active_Seconds < 60 Then

Rate_Of_Flow(Temp) = Cars_Moving_Per_Lane(Temp)

Else ′OVER 60 SECONDS SINCE STARTUP...

If Number_Of_Active_Seconds > txtTime.Text Then

Number_Of_Active_Seconds = txtTime.Text

End If
Temp2 = 60 / Number_Of_Active_Seconds
Rate_Of_Flow(Temp) = Temp2 * Cars_Moving_Per_Lane(Temp)

End If

′Display data for flow here

If Rate_Of_Flow(Temp) > 0.3 Then

txtCPM(Temp).Text = “Cars/minute= ” & Format(Rate_Of_Flow(Temp),

“##0.0”)

Else

txtCPM(Temp).Text = “Very Low Flow: ” & Format(Rate_Of_Flow(Temp),

“##0.0”)

End If

| | |
|---|---|
| ′ | Text3.Text = Number_Of_Active_Seconds |

If Rate_Of_Flow(Temp) <= PBFlow(Temp).Max Then

PBFlow(Temp).Value = Rate_Of_Flow(Temp)

End If

End If

Next
End Sub
′XXXXXXXXXXXXXXXXXXXXXXXXXXXXXXXXXXXXXXXXXXXXXXXXXX

‘this is where we calculate and display the total traffic flow.

Public Sub TotalTrafficFlow( )
Dim Temp As Integer

| | |
|---|---|
| mnuCPM.Caption = “ | ” |
| CPM = 0 | |

FDebug.txtTF.Text = “Traffic Flow Omissions: ”
On Error Resume Next
For Temp = 0 To txtNumOfLanes.Text

If LblLane(Temp).ForeColor = vbGreen Then

If Rate_Of_Flow(Temp) < > “0” Then

CPM = CPM + Rate_Of_Flow(Temp)

Else

FDebug.txtTF.Text = FDebug.txtTF.Text & “Lane # ” & Temp & “: ”

End If

End If

If FlowDataArrived Then

txtTotalTF.Text = “Cars/minute= ” & Format(CPM, “##0.0”)

Else

txtTotalTF.Text = “No Data”

End If
Next
End Sub
′XXXXXXXXXXXXXXXXXXXXXXXXXXXXXXXXXXXXXXXXXXXXXXXXXXX
Private Sub Send_To_Client( )
Dim Temp As Long
Dim Update_List As String
Update_List = “”
Update_List = “TRAFFIC_UPDATE:”
Update_List = Update_List & SITE_NAME & “:”
Update_List = Update_List & txtTotalTF.Text & “:”
If NumberOfActiveLanes < > 0 Then

Update_List = Update_List & txtTotalVPL & “:”

Else

Update_List = pdate_List & 0 & “:”

End If
Update_List = Update_List & txtTotalWT.Text & “:”
Update_List = Update_List & txtTotalWT.Text & “:”
′now send this to winsocks
End Sub
′XXXXXXXXXXXXXXXXXXXXXXXXXXXXXXXXXXXXXXXXXXXXXXXXXXXXXXXX

‘ This is the sub that actually sends commands to camera and switcher to select a new camera position through camera movement and camera selection. This sends out an 8 byte string that is specific for one type of Pan/Tilt/Zoom camera. The program could be used with any PTZ camera by simply changing the commands sent out. Also, the system does not need a PTZ camera. Multiple fixed cameras can also be used.

Public Sub GotoHere(Index As Integer)
Dim Temp As Long
Dim TypeOfFile As String
Dim Message As String
On Error Resume Next
Waiting_For_Move = True
If Index >= txtC.UBound Then Index = txtC.UBound
txtCamLocation.Text = “Camera Moving to ” & Index + 1 & “.”
′txtC(index) is txtCamera number
CurrentCam = txtC(Index).Text
If CurrentCam = −1 Then

Switch_Local_Video_Channel (Index)
GoTo FinishSub

End If
DataOK(CurrentCam) = True
′txtx is x position, y is y position, txtz is zoom
Xm = txtX(Index)
Ym = txtY(Index)
Zm = txtZ(Index)
Filem = txtFileName(Index)
′txtlocation is the motherboard (switcher) location
Byte0 = txtLocation.Text
Byte2 = 199
If CurrentCam = 0 Then

MsgBox (“Please select a camera. Current camera is 0.”)
GoTo FinishSub

End If

SendOut1′ this function send bytes 0 through 8 to the comm. Port. This could also send to a winsock port so that another machine could send data out from another location.

Sleep 550, True
Switch_Local_Video_Channel (Index)
Filem = txtFileName(Index)
Byte2 = 23
Byte3 = Zm
SendOut1
End If ′klug
GoTo FinishSub
showerr:
MsgBox (“One of fields is empty... X, Y, or Z is blank”)
FinishSub:
TypeOfFile = “FILE“
Call_New_File TypeOfFile, Index ′Call C++
Waiting_For_Move = False
End Sub
′XXXXXXXXXXXXXXXXXXXXXXXXXXXXXXXXXXXXXXXXXXXXXXXXXXXXXXX
Virtual flow

‘On the display of any single lane, a user can press down on a mouse to provide virtual data information. This data, while only displayed while pressing on the mouse in this embodiment, could be displayed all the time in other embodiments, or at specific times. The current embodiment works as follows.
While the program is in operation, a user can press any lane number. If the lane is currently displaying data then the lane is active. By clicking on it, the program provides virtual data—to show what the current flow rate and wait time would be if this lane were closed. If the user clicks on a lane that is not displaying data (suggesting it is not currently active) then the program increases the flow rate and reduces the wait time by adding to the total flow rate the average of all currently active lanes. To add one additional lane, add the average once. To add two virtual lanes, double the average. These numbers are displayed in a text box that indicates it is the “Virtual Wait Time”

This is the sub routine:

Private Sub LblLane_MouseDown(Index As Integer, Button As
Integer, Shift As
Integer, X As Single, Y As Single)
Dim Temp2 As Long
Dim VIRTUAL_ADD As Boolean
RELEASE_WAIT = True
REPORT_DATA_TO_DISPLAY Last_Camera_Position +
1 , LANE_STATUS
CPM_TEMP = 0

‘if the lable is green, then it is active. If it is active AND its flow rate is significantly more that 0 then assume the lane is active. In this case, reduce the value of this lane from the total.

If LblLane(Index).ForeColor = vbGreen And Rate_Of_Flow(Index) > 0.3 Then

For Temp = 0 To txtNumOfLanes.Text

If LblLane(Index).ForeColor = vbGreen And Rate_Of_Flow(Temp) > 0.3 Then

If Temp < > Index Then ′don't include this one

CPM_TEMP = CPM_TEMP + Rate_Of_Flow(Temp)

End If

End If

Next

VIRTUAL_ADD = False

Else

VIRTUAL_ADD = True
If LblLane(Index).ForeColor < > vbGreen Then

′Add one more lane

ADD_TO_FLOW_AVERAGE (Index)

Else

Msg = “Add Virtual lane #” & Index + 1 & “ ?” ′ Define message.
Style = vbYesNo + vbNormal + vbDefaultButton2 ′ Define buttons.
Title = “Lane Appears Inactive: ” ′ Define title.
Response = MsgBox(Msg, Style, Title, Help, Ctxt)
If Response = vbYes Then ′ User chose Yes.
′Add one more lane

ADD_TO_FLOW_AVERAGE (Index)

End If
Exit Sub

End If

End If
If CPM_TEMP < 1 Then
′nada
Else

Number_Of_Lanes_Adding = Index + 1 − txtNumOfLanes.Text
If VIRTUAL_ADD Then

Lbl Virtual.Caption = “Virtually Adding ” & Number_Of_Lanes_Adding & “ Lanes.”
Lbl_Virtual.Visible = True

Else

Lbl_Virtual.Caption = “Virtually Subtracting Lane ” & Index & “.”
Lbl_Virtual.Visible = True

End If
If TOTAL_VEHICLES = 999 Then

Temp2 = Total_Vehicles_temp

Else

Temp2 = TOTAL_VEHICLES

End If
If Temp2 / CPM_TEMP > 200 Or Temp2 / CPM_TEMP <= 0 Then

txtAltered_WT.Text = “Error in Data”

Else

txtAltered_WT.Text = Format(Temp2 / CPM_TEMP, “##0.0”) & “ Min.”

End If

End If
txtAltered_WT.Visible = True
End Sub
′XXXXXXXXXXXXXXXXXXXXXXXXXXXXXXXXXXXXXXXXXXXXXXXXXXXXXXX
Private Sub ADD_TO_FLOW_AVERAGE(Lane_Clicked As Long)
Dim Number_Of_Lanes_Used As Long
Dim Average_Flow As Variant
Number_Of_Lanes_Used = 0
′Get the total for all lanes with more than .3

For Temp = 0 To txtNumOfLanes.Text

If LblLane(Index).ForeColor = vbGreen And Rate_Of_Flow(Temp) > 0.3 Then

CPM_TEMP = CPM_TEMP + Rate_Of_Flow(Temp)
Number_Of_Lanes_Used = Number_Of_Lanes_Used + 1

End If

Next

′Get the average of all lanes

If Number_Of_Lanes_Used > 1 Then

′nada

Else

Number_Of_Lanes_Used = 1

End If
Average_Flow = CPM_TEMP / Number_Of_Lanes_Used

′Multiply the Average by the number of added lanes
If Lane_Clicked + 1 > txtNumOfLanes.Text Then

If Average_Flow > 0 Then

′nada

Else

MsgBox (“Flow Average is 0. Can not proceed with Virtual assessment.”)
Exit Sub

End If

Average_Flow = Average_Flow * (Lane_Clicked + 1 − txtNumOfLanes.Text)

′Add the average to the total value
End If

CPM_TEMP = CPM_TEMP + Average_Flow

End Sub
′XXXXXXXXXXXXXXXXXXXXXXXXXXXXXXXXXXXXXXXXXXXXXXXXXXXXXXX
C++ code explanation:

1. A traffic assessment system comprising:
a. a vessel monitor configured to monitor vessels in one or more open traffic lanes that are waiting to pass through one or more flow regulation controls associated with the one or more open traffic lanes;
b. a flow monitor configured to monitor the flow of vessels passing through the one or more flow regulation controls; and
c. an analyzer configured to determine the likely effect of opening one or more closed traffic lanes or closing one or more of the open traffic lanes on the waiting time of a waiting vessel based on information from the vessel monitor and the flow monitor.

2. A traffic control system comprising:
a. a traffic assessment system configured to assess the waiting time a vessel entering an area controlled by one or more flow regulation controls is likely to need to wait before passing through the controlled area; and
b. a transmitter for transmitting information about the waiting time to vessels not in the controlled area.

3. A traffic assessment system comprising:
a. a camera system configured to create an image of at least a portion of an area that receives vessels and that is controlled by one or more vessel flow regulation controls;
b. a vessel recognition system configured to analyze information about vessels within a defined area of the image; and
c. a user interface configured to allow a user to define the area of the image from the camera system that should be analyzed by the vessel recognition system.
